(19) United States
(12) Patent Application Publication
(10) Pub. No.: US 2025/0289665 A1
(43) Pub. Date: Sep. 18, 2025

(54) FASTENER ASSEMBLY FOR CABLE CONVEYOR BELT

(71) Applicant: Flexible Steel Lacing Company, Downers Grove, IL (US)

(72) Inventors: Brett E. DeVries, Comstock Park, MI (US); Russell Vaughn Heintz, Romeoville, IL (US)

(21) Appl. No.: 19/076,689

(22) Filed: Mar. 11, 2025

Related U.S. Application Data
(60) Provisional application No. 63/564,486, filed on Mar. 12, 2024.

(51) Int. Cl. B65G 15/36; F16G 3/10; F16G 11/04

(52) U.S. Cl. CPC B65G 15/36; F16G 11/048; F16G 3/10

(57) ABSTRACT

In one aspect, a fastener assembly for joining first and second cable end portions of a cable conveyor belt. The fastener assembly includes a first cable fastener having a first head portion and a first plurality of locking members to secure the first cable fastener to the first cable end portion. The fastener assembly includes a second cable fastener having a second head portion and a second plurality of locking members to secure the second cable fastener to the second cable end portion. The fastener assembly further includes a connector having a first pocket sized to receive the first head portion and a second pocket sized to receive the second head portion, the first and second pockets and the first and second head portions configured to permit shifting of the first and second cable fasteners relative to the connector during operation of the cable conveyor belt.

### CROSS-REFERENCE TO RELATED APPLICATION(S)

This application claims the benefit of U.S. Provisional Application No. 63/564,486 filed Mar. 12, 2024, which is incorporated herein by reference in its entirety.

### TECHNICAL FIELD

This disclosure relates to splices for conveyor belts and, more specifically, to splices for conveyor belts containing cables.

### BACKGROUND

Steel cable conveyor belts contain rubber and cables embedded in the rubber that extend the length of the conveyor belt. The steel cables often have a diameter in the range of 3 mm to 13 mm. The cables provide tensile strength to the conveyor belt as the conveyor belt is loaded with conveyed material and goes over and around pulleys along the path of the conveyor belt. The tension in each cable is shared with nearby cables by rubber that extends between the cables and which is placed in shear as the cables are placed in tension.

Steel cable conveyor belts are typically used in heavy-duty applications. The loads carried by these conveyor belts are typically measured in tons. In addition, the conveyor belts are large and can extend a half mile or more, and can be four feet in width or more. Steel cable conveyor belts must have high strength to withstand these operating conditions. In this regard, steel cable conveyor belts can have working load ratings that range from 800 pounds per inch width (PIW) to 8,500 PIW. Given the size and construction of steel cable conveyor belts, it is often difficult to repair a steel cable belt when the belt is damaged. Steel cable conveyor belts may be damaged by, for example, a very heavy object falling onto the conveyor belt or an object tearing the belt.

Connecting the ends of a new steel cable conveyor belt or repairing a severely damaged steel cable conveyor belt is a complicated process that requires a high degree of skill, specialized tools, and typically involves a large amount of downtime for the conveyor system. Conventional installation and repair protocols involve a facility shutting down the conveyor and requesting a specialized team visit the facility to repair the conveyor belt. However, where facilities utilizing steel cable conveyor belts are in remote areas, it may be several days before a team can reach the facility.

When the repair team arrives at the facility, a temporary shelter is usually erected to protect the damaged section of the conveyor belt from the environment. The damaged section of belting is identified and the entire damaged section is typically removed by cutting the section out completely. This leaves the ends of the conveyor belt to either be joined together with a single splice between the belt ends or joined together with a new length of belt (sometimes referred to as a “saddle”). When a saddle is used to join the ends, the repair operation involves creating two splices, i.e., one splice between one belt end and the saddle and another belt splice between the other belt end and the saddle.

For example, to prepare the conveyor belt for vulcanized splicing, the team first pulls off a top cover of the belt at one of the freshly cut ends of the remaining undamaged conveyor belt, separates the cables from the rubber of a lower cover of the conveyor belt at the one end, and pulls off the lower cover at the one end. Any rubber remaining on the cables is trimmed off by hand. The exposed cables are then each cut to a predetermined length according to splice instructions from the steel cable belt manufacturer. This belt end preparation process is repeated at the other end of the conveyor belt.

The team then positions a lower platen of a vulcanizing press below the prepared conveyor belt ends. Vulcanizing presses for steel cable conveyor belts are often very large and require a crane to lift the vulcanizing press into position. The cables of the conveyor belt ends are cleaned and specialized cement is applied to the cables to prepare the cables to bond with the rubber of the splice. Next, a lower cover of the splice is positioned below the cables and the cables are arranged in a pattern according to the splice instructions from the conveyor belt manufacturer. Uncured strips of rubber, sometimes referred to as noodles, and gap filler are used to fill the areas between the cables. An upper cover of the splice is then positioned on the cables.

Using a crane, the upper platen of the vulcanizing press is positioned on the upper cover to sandwich the upper cover, steel cables, and lower cover between the upper and lower platens of the press. The vulcanizing press is operated to raise the temperature of the splice to a predetermined temperature and compress the splice with a predetermined pressure. After the vulcanization process is complete, the team uses the crane to remove the upper platen. The splice is lifted off the lower platen so that the splice may cool. The lower platen is subsequently removed from the conveyor belt and the conveyor belt is ready for use. For higher tension belts, splice length can be 15 feet or more and require multiple vulcanizing cycles as the presses are not long enough to heat the entire splice length and must be moved longitudinally along the splice length to do so.

As will be appreciated, the conventional approach using a vulcanized splice for repairing a steel cable conveyor belt is labor and time intensive and may take several days to get the conveyor belt up and running again. This downtime adversely affects the productivity of the facility, especially for large-scale operations that depend on the conveyor belt to carry tons of aggregate or other material every hour.

U.S. Pat. No. 11,022,197 to Dailey et al. discloses a mechanical splice for joining ends of a steel cable conveyor belt. The splice includes fasteners that are connected to cables projecting outward from the conveyor belt ends. The fasteners have loops that are aligned to receive a hinge pin which connects the fasteners of the conveyor belt ends. The hinge pin may include a cable having bundles of wires that provides flexibility to the splice while being sufficiently strong to resist the loads applied to the hinge pin by the fasteners during operation of the steel cable belt.

Heavy duty steel cable conveyor belts have a breaking strength of 2500 N/mm or higher and are subject to high tension as they convey heavy loads during conveyor belt operation. Some commercially available hinge pins may be unable to withstand the extreme forces applied to the splice during operation of the conveyor belt. Thus, a mechanical splice that utilizes a hinge pin may be commercially impractical for heavy duty steel cable conveyor belts.

Another issue with mechanical splicing of heavy-duty steel cable conveyor belts is that the conveyor belt has large diameter cables, such as 8 mm or larger, that are tightly arranged across the conveyor belt to withstand the high working loads experienced by the conveyor belt. For example, a conveyor belt having a 2500 N/mm breaking strength may have steel cables with a diameter of 6.4 mm and a pitch of 15 mm between the centers of adjacent cables, whereas a conveyor belt having a 3500 N/mm breaking strength may have a cable diameter of 8 mm and a pitch of 17 mm or less between the centers of adjacent cables. This relatively narrow spacing between cables of a heavy duty steel cable conveyor belt can make it challenging to use a mechanical splice to join the ends of the heavy-duty steel cable conveyor belt.

### SUMMARY

In one aspect of the present disclosure, a fastener assembly is provided for joining first and second cable end portions of a cable conveyor belt. The fastener assembly includes a first cable fastener having a first head portion and a first plurality of locking members to secure the first cable fastener to the first cable end portion. The fastener assembly includes a second cable fastener having a second head portion and a second plurality of locking members to secure the second cable fastener to the second cable end portion. The fastener assembly further includes a connector having a first pocket sized to receive the first head portion and a second pocket sized to receive the second head portion, the first and second pockets and the first and second head portions configured to permit shifting of the first and second cable fasteners relative to the connector during operation of the cable conveyor belt. The fastener assembly enables a secure connection between the cable end portions while allowing the first and second cable fasteners to move, such as when the fastener assembly and cable end portions travel around a pulley, which improves the durability of the fastener assembly.

The present disclosure also provides a cable fastener for connecting cable end portions of a conveyor belt. The cable fastener includes a body having a bore to receive a cable end portion, an inner surface of the body extending around the bore, a plurality of narrow outer surfaces of the body, and a plurality of wide outer surfaces of the body alternating with the narrow outer surfaces about the body. The cable fastener further includes rows of threaded through openings of the narrow outer surfaces, the threaded through openings extending to the inner surface. The cable fastener includes set screws in the threaded through openings that are operable to secure the cable end portion in the bore. The body has thicker portions extending between the inner surface and the narrow outer surfaces to strengthen the body adjacent the rows of threaded through openings. The body also includes thinner portions extending between the inner surface and the wider outer surfaces to allow the cable fastener to be compactly positioned adjacent to a fastener secured to an adjacent cable end portion of the conveyor belt. In this manner, one of the wide outer surfaces of the cable fastener can be positioned in close proximity to one of the narrow outer surfaces of the fastener secured to the adjacent cable end portion and avoid lateral displacement of the adjacent cable end portions caused by contact between the cable fasteners.

In accordance with another aspect of the present disclosure, a method is provided for connecting cable end portions of a cable conveyor belt. The method includes securing cable fasteners to the cable end portions, aligning head portions of the cable fasteners with pocket portions of connector members, and shifting the connector members of a connector together so that the pocket portions extend about the head portions and form pockets of the connector. The method further includes securing the connector members together to capture the head portions of the fasteners in the pockets of the connector.

### BRIEF DESCRIPTION OF DRAWINGS

FIG. 1 is a perspective view of a mechanical splice joining the ends of a heavy duty steel cable conveyor belt;

FIG. 2 is a plan view of two fastener assemblies of the splice of FIG. 1 connecting cables of the conveyor belt ends;

FIG. 3 is a cross-sectional view taken along line 3-3 of FIG. 2 showing one of the fastener assemblies connecting end portions of cables of the conveyor belt ends, the fastener assembly including two cable fasteners secured to the two cable end portions and an intermediate connector connecting the fasteners;

FIG. 4 is a cross-sectional view of one of the fasteners of FIG. 3 showing set screws of the cable fastener securing the cable fastener to the cable end portion and the cable end portion extending linearly straight out from an inboard entry opening of the fastener toward the belt end;

FIG. 5 is a cross-sectional view similar to FIG. 4 showing the cable end portion bending in the area of the fastener entry opening as the splice travels around a pulley;

FIG. 6A is a cross-sectional view taken along line 6A-6A of FIG. 2 showing adjacent cable fasteners rotationally offset relative to one another to permit close positioning of the cable fasteners secured to the cables without interference between the set screws of the adjacent fasteners;

FIG. 6B is a cross-sectional view taken along line 6B-6B in FIG. 2 showing thicker portions of bodies of the cable fasteners between the threaded openings that receive the set screws of the fastener;

FIG. 7 is a perspective view of the fastener assembly of FIG. 3 showing one of the cable fasteners extending through an end entry opening of the connector;

FIG. 8 is an elevational view of one of the cable fasteners showing a distal head portion connected to a narrowed neck portion with the head portion including a stepped profile for engaging a corresponding stepped profile of a pocket of the connector;

FIG. 9 is a cross-sectional view taken along line 9-9 of FIG. 7 showing engaged curved surfaces of the fastener neck portion and a rim portion of the connector, and a conical leading surface of the fastener distal head portion that permits limited pivoting of the fastener relative to the connector during operation of the conveyor belt;

FIG. 10 is an elevational view of an inboard or proximate end of one of the cable fasteners of FIG. 7 showing a blind bore for receiving a cable end portion and set screws that are driven to extend into the blind bore for engaging bundles of wires of the cable end portion;

FIG. 11 is an elevational view of an outboard or distal end of the cable fastener of FIG. 10 showing the frustoconical leading surface of the fastener;

FIG. 12 is a perspective view of the connector of FIG. 7 showing upper and lower connector members secured together with a screw;

FIG. 13 is an exploded view of the connector of FIG. 12 showing both of the upper and lower concave recessed openings at one of the ends of the corresponding upper and lower connector members that cooperate to form the end entry opening of the connector at the corresponding one end thereof for receiving the neck portion of one of the fasteners;

FIG. 14 is a bottom plan view of the upper connector member showing recessed pocket portions formed at both ends thereof;

FIG. 15 is a top plan view of the lower connector member of FIG. 13 showing the lower semi-circular recessed pocket portions formed at both ends thereof and that cooperate with the recessed pocket portions of the upper connector member to form pockets of the connector that receive the head portions of the cable fasteners;

FIG. 16 is a cross-sectional view taken along line 16-16 of FIG. 12 showing semicircular stop surface portions of the upper and lower connector members forming annular stop shoulder surfaces of the connector with the upper and lower connector members secured together;

FIG. 17 is a perspective view of an alternative fastener for repairing a damaged steel cable conveyor belt;

FIG. 18 is an end elevational view of the fastener of FIG. 17 showing a bore for receiving a cable end portion and a set screw driven to extend into the bore for engaging the cable end portion;

FIG. 19 is a cross-sectional view taken along line 19-19 of FIG. 17 showing set screws of the fastener that secure cable end portions in a pair of bores of the fastener;

FIGS. 20A is a flow chart of a method of repairing a hole in a steel cable conveyor belt using fasteners that are the same as the fastener of FIG. 17;

FIGS. 20B-27 are plan and cross-sectional views of a portion of the steel cable conveyor belt illustrating the method of FIG. 20A;

FIG. 28A is a flow diagram of a method of applying fasteners to cable end portions of a conveyor belt;

FIGS. 28B-32 are cross-sectional views of cable end portions and fasteners illustrating the method of FIG. 28A;

FIG. 33A is a flow diagram of a method of applying fasteners to cable end portions of a conveyor belt;

FIGS. 33B-38 are cross-sectional views of cable end portions and fasteners illustrating the method of FIG. 33A;

FIG. 39 is a perspective of a fastener having longitudinally offset rows of openings to receive set screws;

FIG. 40 is a cross-sectional view taken along line 40-40 of FIG. 39 showing the set screw through openings in communication with a blind bore of the fastener;

FIG. 41 is a plan view of a two-stage conveyor belt splice assembled using two longitudinally offset groups of fastener assemblies;

FIG. 42 is an enlarged view of the area shown in a dashed box in FIG. 41; and

FIG. 43 is a view similar to FIG. 42 with the fastener assemblies removed to show the staggered ends of the cable end portions;

FIG. 44 is a perspective view of another fastener assembly showing upstream and downstream cable fasteners and an intermediate connector having upper and lower connector members connected by fastener member rings at opposite ends of the connector that keep the upper and lower connector members of the connector secured to the upstream and downstream fasteners;

FIG. 45 is a side elevational view of the upstream cable fastener of FIG. 44 showing a narrow neck portion and an adjacent, enlarged head portion at an outboard end of the fastener;

FIG. 46 is a bottom perspective view of the upper connector member showing raised arcuate alignment protrusions extending about a central opening and raised alignment ridges extending radially from the central opening between the arcuate alignment protrusions;

FIG. 47 is a bottom plan view of the upper connector member of FIG. 46 showing upper, end pocket portions of the upper connector member configured to receive the head portions of the upstream and downstream cable fasteners;

FIG. 48 is a top perspective view of a lower connector member of the connector of FIG. 44 showing a central alignment recess extending about a central opening and alignment recesses extending radially from the central opening to receive, respectively, the raised arcuate alignment protrusions and raised alignment ridges of the upper connector member;

FIG. 49 is a top plan view of the lower connector member of FIG. 48 showing lower, end pocket portions of the lower connector member configured to receive the head portions of the upstream and downstream fasteners;

FIG. 50 is a cross-sectional view taken along line 50-50 in FIG. 44 showing the head portion of the upstream fastener received in a connector pocket formed by the upper and lower pocket portions of the upper and lower connector members;

FIG. 51 is a cross-sectional view similar to FIG. 50 showing the upstream cable fastener pivoted upwardly relative to the connector and a partially spherical surface of the head portion engaged with a partially spherical surface of the connector pocket;

FIG. 52 is a cross-sectional view similar to FIG. 51 showing the upstream cable fastener pivoted downwardly relative to the connector;

FIGS. 53-56 are a series of cross-sectional views showing a method for connecting cable end portions of a cable conveyor belt using the fastener assembly of FIG. 44 wherein FIG. 53 shows the upstream and downstream cable fasteners secured to the cable end portions and head portions of the upstream and downstream fasteners aligned with the upper and lower pocket portions of the upper and lower connector members;

FIG. 54 is a view similar to FIG. 53 showing the upper and lower connector members shifted together and the head portions of the upstream and downstream cable fasteners received in the upper and lower pocket portions of the upper and lower connector members;

FIG. 55 is a view similar to FIG. 54 showing a threaded attachment member of the connector securing the upper and lower connector members together to capture the head portions of the cable fasteners in the end pockets of the connector;

FIG. 56 is a view similar to FIG. 55 showing the rings of the connector advanced onto end annular flange portions of the connector to keep the upper and lower connector members secured onto the head portions of the upstream and downstream fasteners during conveyor belt operation;

FIG. 57 is a cross-sectional view taken along line 57-57 in FIG. 44, showing the head portion of the cable fastener in the pocket portion of the lower connector member;

FIG. 58 is a side elevational view of the connector assembly of FIG. 44 showing the upstream cable fastener pivoted upwardly and the downstream cable fastener pivoted downwardly from a central horizontal axis of the connector;

FIG. 59 is a top plan view of the fastener assembly of FIG. 58 showing the upstream cable fastener pivoted laterally outward to extend transversely at an oblique angle relative to a central longitudinal axis of the fastener assembly and the downstream cable fastener pivoted laterally outward in an opposite direction away from the central longitudinal axis; and

FIG. 60 is a cross-sectional view taken along line 60-60 in FIG. 58 showing the head portions of the upstream and downstream cable fasteners tilted within the lower pocket portions of the lower connector member due to the laterally inclined orientation of the upstream and downstream cable fasteners.

### DETAILED DESCRIPTION

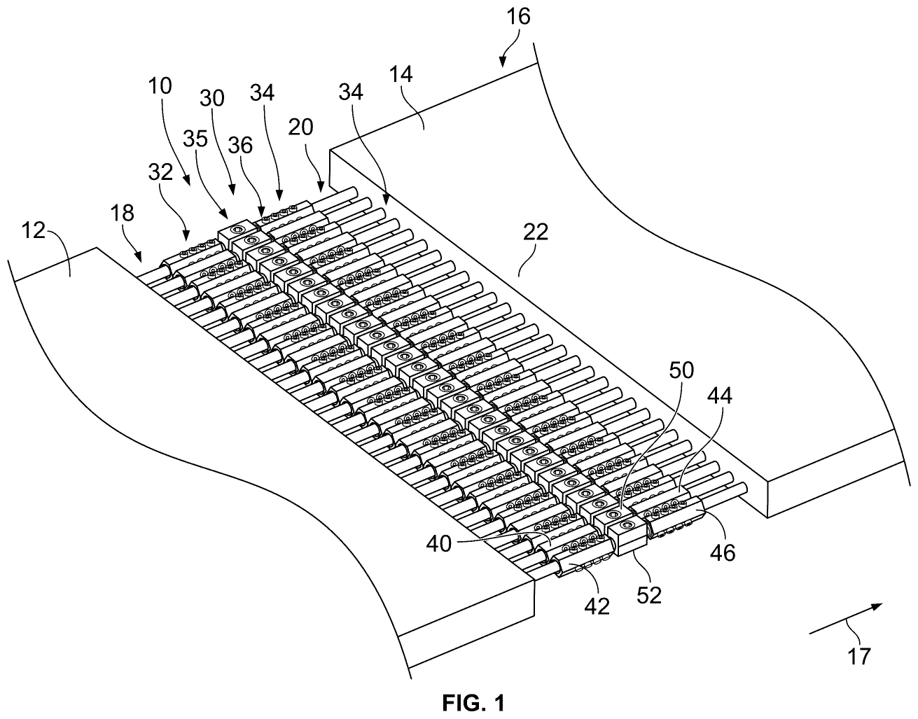

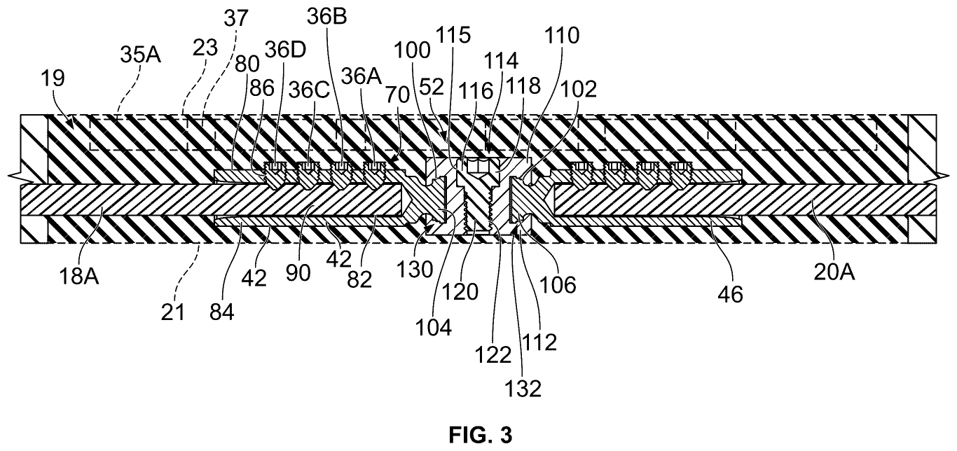

Referencing FIG. 1, a splice 10 is shown that mechanically joins ends 12, 14 of a heavy-duty steel cable conveyor belt 16 that is driven in a downstream, longitudinal direction 17 to convey objects such as aggregate. The ends 12, 14 include cable end portions 18, 20 that have been exposed by removing a portion of a body 22 of the conveyor belt 16. The splice 10 is shown in FIG. 1 with a filler 19 (see FIG. 3), such as solidified urethane, removed to clearly show the components of the splice 10. In FIG. 3, the filler 19 is shown and the filler 19 provides an upper surface 23 for supporting conveying material and a lower surface 21 for contacting pulleys.

The splice 10 includes fastener assemblies 30 that each join an aligned pair of cable end portions 18, 20. The aligned pairs of cable end portions 18, 20 may each be the opposite end portions of one cable or may be end portions of different cables embedded in the belt 16. The filler 19 embeds the fastener assemblies 30 therein and can assist in keeping the fastener assemblies 30 secured to the cable end portions 18, 20.

The fastener assemblies 30 include upstream cable fasteners 32 connected to corresponding upstream cable end portions 18, downstream cable fasteners 34 connected to the corresponding downstream cable end portions 20, and intermediate connectors 35 joining the upstream and downstream fasteners 32, 34. The upstream and downstream cable fasteners 32, 34 have locking members, such as set screws 36, that secure the upstream and downstream cable fasteners 32, 34 to the cable end portions 18, 20.

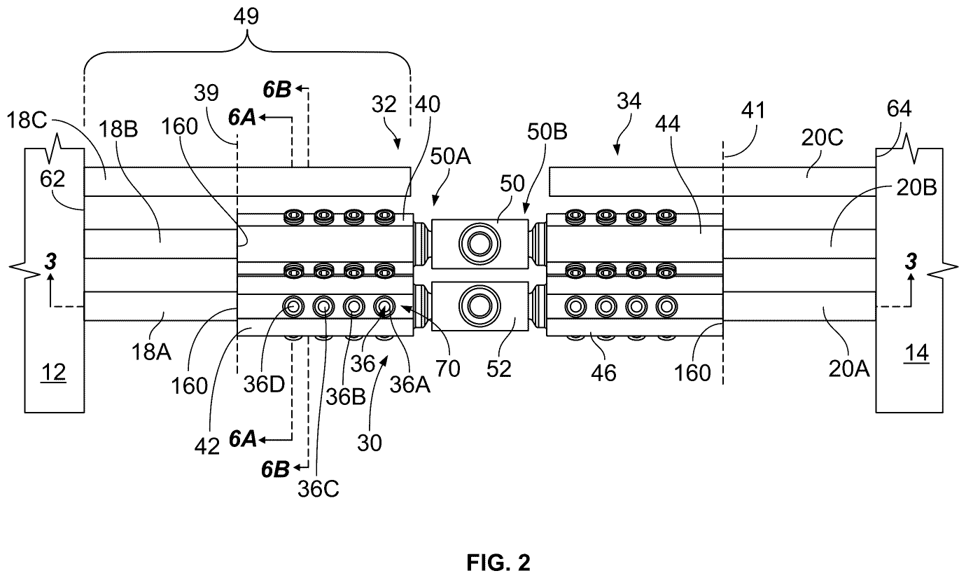

As shown in FIG. 2, the upstream cable fasteners 32 include adjacent upstream cable fasteners 40, 42, the downstream cable fasteners 34 include adjacent downstream cable fasteners 44, 46, and the connectors 35 include intermediate connectors 50, 52. The upstream cable fastener 42 will be discussed in greater detail below with the understanding that the other upstream cable fasteners 32, including upstream cable fasteners 40, 42, and the downstream cable fasteners 34, including downstream cable fasteners 44, 46, will have the same or similar construction.

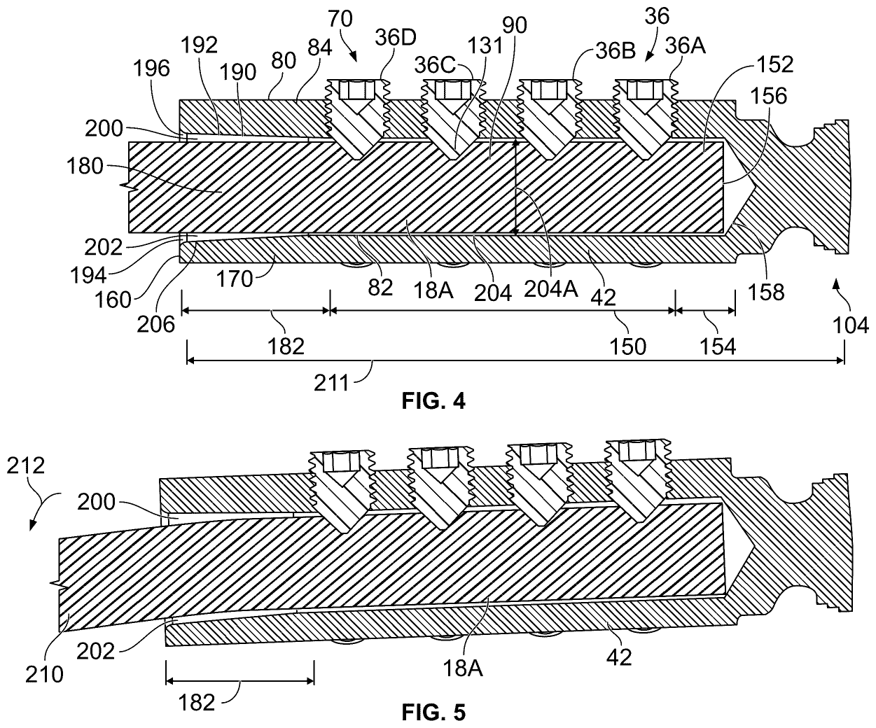

During installation of the splice 10, the upstream and downstream cable fasteners 32, 34 may be secured one at a time to the respective upstream and downstream cable end portions 18, 20 by inserting the cable end portion 18, 20 into a blind bore 82 (see FIG. 3) of the fastener 32, 34 and advancing the fastener 32, 34 to a desired longitudinal position along the respective cable end portions 18, 20. The upstream fasteners 32 are positioned on the cable end portions 18 so that the upstream fasteners 32 are laterally aligned across the conveyor belt end 12. Likewise, the downstream cable fasteners 34 are positioned on the cable end portions 20 so that the downstream cable fasteners 34 laterally aligned across the conveyor belt end 14. For example and with reference to FIG. 2, the upstream cable fasteners 40, 42 are laterally aligned by positioning inboard end surfaces 160 (see FIG. 4) of the upstream cable fasteners 40, 42 on a lateral axis 39 and the downstream cable fasteners 44, 46 are laterally aligned by positioning inboard end surfaces 160 of the downstream cable fasteners 44, 46 on a lateral axis 41. Laterally aligning the upstream cable fasteners 32 on the cable end portions 18 and laterally aligning the downstream cable fasteners 34 on the cable end portions 20 limits uneven application of force to the splice 10 during operation of the conveyor belt 16.

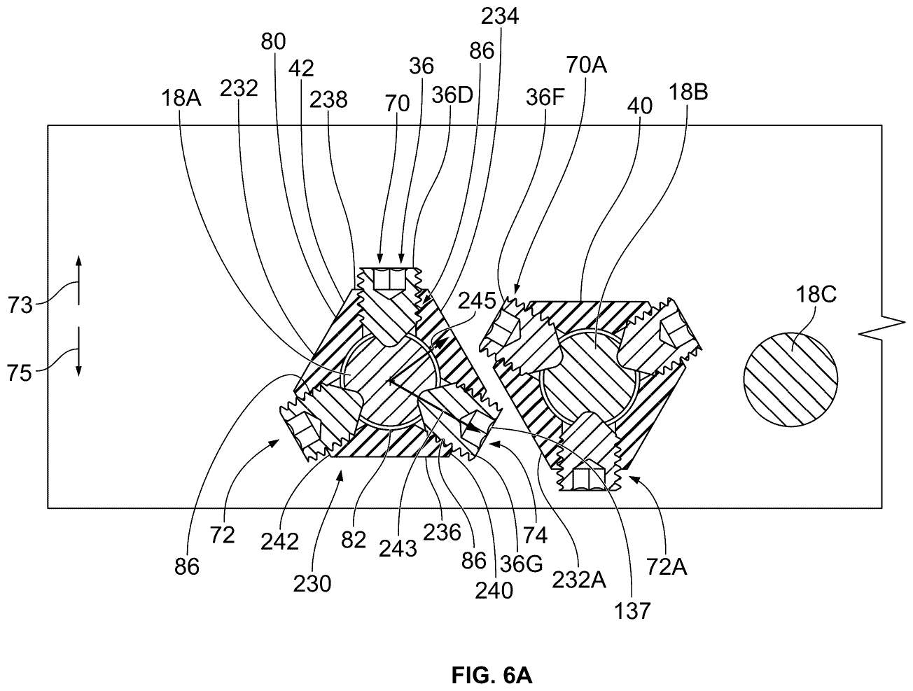

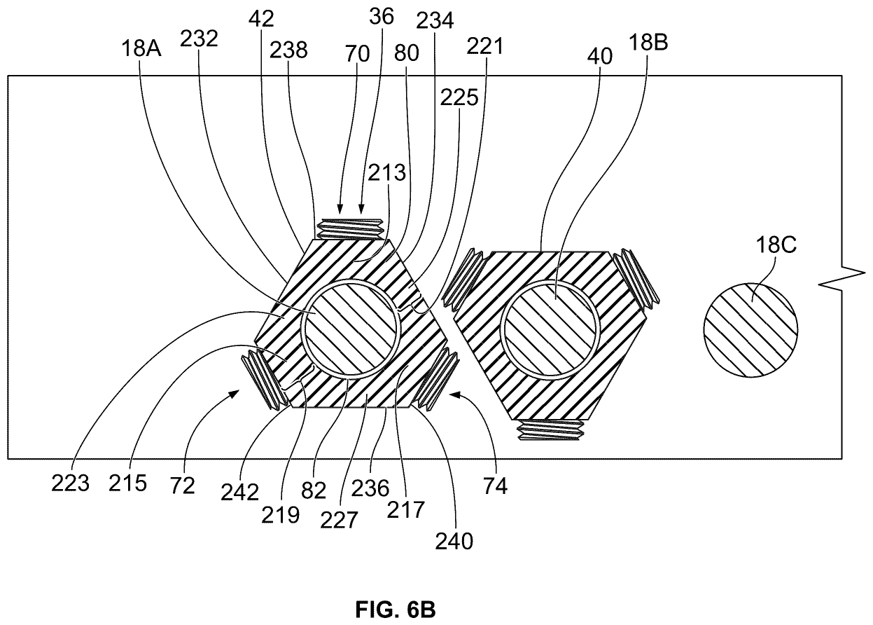

To align the upstream and downstream cable fasteners 32, 34 on the cable end portions 18, 20, an installer may use a guide such as an angle iron. Specifically, the installer first positions one leg of the angle iron to extend laterally across the cable end portions 18 generally orthogonal thereto spaced from the fasteners 32 having the cable end portion 18 received therein. The installer then advances each upstream cable fastener 32 along the cable end portion 18 until an inboard end surface 160 (see FIG. 4) thereof abuts the angle iron. The inboard end surface 160 is closest to the upstream belt end 12. The installer then tightens down the set screws 36 of the upstream cable fastener 32 to fix the fastener 32 to the cable end portion 18. The set screws 36 may be tightened down by first tightening down one of the set screws 36 (e.g., set screw 36D in FIG. 4) farthest away from a distal head portion 104 or closest to the inboard end surface 160 of each of the fasteners 32, tightening down each of the other set screws (e.g., set screws 36A-C) in the corresponding row (e.g., row 70 in FIG. 4) of the set screws 36, then performing similar operations on the set screws 36 in the other rows 72, 74 (see FIG. 6A) of set screws 36.

The process is repeated until all of the upstream cable fasteners 32 are secured to the cable end portions 18. Next, the installer positions the angle iron in the same manner on the downstream cable end portions 20 and performs a similar process for each of the downstream cable fasteners 34. The upstream and downstream cable fasteners 32, 34 may then be connected via the intermediate connectors 35.

Referring to FIG. 2, the upstream cable end portions 18 include cable end portions 18A, 18B, 18C and the downstream cable end portions 20 include cable end portions 20A, 20B, 20C. In FIG. 2, the fastener assembly 30 associated with cable end portions 18C, 20C has been removed to show an exposed length 49 of each of the cable end portions 18A, 18B, 18C that are trimmed of surrounding rubber and protrude from end surface 62 of the end 12 of the conveyor belt 16 before they are inserted in the fasteners 32. Likewise, the cable end portions 20A, 20B, 20C protrude from an end surface 64 of the end 14 of the conveyor belt 16. Each pair of cable end portions 18A, 20A, etc. may be opposite end portions of a single cable or may be end portions of different cables.

As shown in FIGS. 3 and 6A, the fastener 42 has a body 80 with a bore, such as a blind bore 82, and a tubular wall 84 extending thereabout. The fastener 42 has rows 70, 72, 74 of aligned set screws 36 with row 70 including set screws 36A-36D. The tubular wall 84 has rows of threaded openings 86 that receive the set screws 36A-36D and permit the set screws 36A-36D to be driven into engagement with a secured length 90 of the cable end portion 18A received in the blind bore 82. The body 80 may be made of a durable, high strength material such as steel. Example materials include 4140 pre-hardened steel and tempered 17-4 PH stainless steel.

As can be seen in FIG. 3, the connector 52 has recessed pockets 100, 102 that receive distal annular head portions 104, 106 of the fasteners 42, 46. The connector 52 has upper and lower connectors members 110, 112 secured together with an attachment member 114, such as a bolt or a screw. In one embodiment, the attachment member 114 is a socket head screw 116. The socket head screw 116 has an enlarged head portion 118 that is received in countersink opening 115 of the upper connector member 110 and a threaded shank portion 120 that engages aligned threaded bore 122 of the lower connector member 112. The upper and lower connector members 110, 112 may be made of a durable, high strength material such as steel. Example materials include 4140 pre-hardened steel and tempered 17-4 PH stainless steel. The socket head screw 116 may be made of a high strength alloy.

Once the splice 10 has been installed, the tensile load on the cable end portions 18A, 20A causes the head portions 104, 106 to tightly abut the stop surfaces 130, 132 of the connector 52. The engaged head portions 104, 106 and stop surfaces 130, 132 inhibit pull-out of the fasteners 42, 46 from the connector 52 and thereby maintain a mechanical connection between the cable end portions 18A, 20A via the fastener assembly 30.

The cables of the conveyor belt 16 may each be an assembly of bundles of wires, such as seven bundles of wires for a cable with nineteen wires per bundle. The wires of the cable end portion 18 are held in fixed relation to the fastener 42 by the set screws 36 of the fastener 42 and form a secured length 90 of the cable end portion 18A in the blind bore 82 as shown in FIG. 3. Referencing FIG. 4, the set screws 36A-36D each have a tapered leading end portion 131 that extends into the blind bore 82 to engage the bundles of wires of the cable end portion 18A and disrupts the wires to wedge into the cable end portion 18A such as between individual wires. With reference to FIG. 6A, the tapered leading end portion 131 also imparts a compressive force on the wires that cooperates with the compressive force applied by the set screws 36 of the other rows 72, 74 of set screws 36 to create localized, tightly compressed portions of the wires at and between the set screws 36. The portions of the wires of the cable end portion 18A intermediate the set screws 36 are less compressed. The less-compressed portions of the wires intermediate the longitudinally spaced set screws 36 provide wider portions that contact the set screws 36 and can further resist pull-out of the cable end portion 18A from the fastener 42.

Continuing reference to FIG. 4, the blind bore 82 of the fastener 42 has an outboard section 150 of its total length in which the rows 70, 72, 74 of set screws 36 engage the cable end portion 18A. The length of the blind bore 82 is sized to extend beyond the most outboard set screws (e.g., set screw 36A) of the rows 70, 72, 74 by a longitudinal distance 154. In this manner, an endmost portion 152 of the cable end portion 18A can extend this distance 154 beyond the outboard set screws before a distal end 156 of the cable end portion 18A engages an end surface 158 of the blind bore 82. The distance 154 accommodates some variation in the length of the cable end portions 18A during installation of the upstream and downstream cable fasteners 32, 34. For example, for shorter upstream cable end portions 18, the portion 152 of the cable may not extend all the way to the end surface 158 of the blind bore 82.

The cable end portion 18A is shown in FIG. 4 as linearly extending straight out of an inboard entry opening 194 of the blind bore 82 such as when the splice 10 is traveling between rollers of the associated conveyor belt system. The fastener 42 has an inboard spacer portion 170 extending longitudinally inboard of the most inboard set screw 36 that spaces the inboard end surface 160 of the fastener tubular wall 84 by a longitudinal distance 182 from the most inboard set screws (e.g., set screw 36D) of the rows 70, 72, 74. The inboard spacer portion 170 of the fastener 42 provides a stress relief portion 180 of the cable end portion 18A in the blind bore 82. While the portions of the wires engaged by the set screws 36 are fixed against movement, the portions of the wires in the stress relief portion 180 of the cable end portion 18A can shift relative to one another to relieve stress in the wires of the cable end portion 18A that can occur due to repeated flexing or bending of the cable end portions 18A such as when they travel around conveyor pulleys. Thus, the stress relief portion 180 of each of the cable end portions 18A can improve the durability of the splice 10.

Referring again to FIG. 4, the tubular wall 84 of the fastener 42 has an interior surface 190 extending about the blind bore 82 with a tapered surface portion 192 and a cylindrical surface portion 204. The tapered surface portion 192 flares outwardly as the interior surface 190 extends in an inboard direction toward the inboard entry opening 194 of the blind bore 82. The tapered surface portion 192 provides greater clearance for movement of the cable end portion 18A in the blind bore 82 as the splice 10 travels around pulleys of the conveyor belt system. The tapered surface portion 192 also includes a proximate end beveled arcuate surface portion 196 extending about the inboard entry opening 194 of blind bore 82 to provide additional clearance to accommodate movement of the cable end portion 18A. The clearance provided by the tapered surface portion 192 reduces stress concentrations in the cable end portion 18A as the cable end portion 18A flexes during troughing and movement of the splice 10 around a conveyor pulley.

The dimensions of the fastener body 80 are sized according to the cable end portion 18A to be received in the blind bore 82. The dimensions include an inner diameter 204A of the cylindrical surface portion 204. The inner diameter 204A is sized to be larger than the diameter or cord size of the cable end portion 18A. For example, the inner diameter 204A is 9.8 mm if the diameter of the cable end portion 18A is 8.1 mm-9.0 mm, the inner diameter 204A is 8.8 mm if the diameter of the cable end portion 18A is 7.1 mm-8.0 mm, and the inner diameter 204A is 7.8 mm if the diameter of the cable end portion 18A is 6.1 mm-7.0 mm.

As can be seen in FIGS. 4 and 6A, there is an annular space 200 between the cable end portion 18A and the tapered surface portion 192. When the splice 10 travels around a pulley, a proximate portion 210 of the cable end portion 18A in the area of the entry opening of the fastener 42 may bend in direction 212 to accommodate the travel of the splice 10 in a curved path around the pulley. As shown in FIG. 5, the upper portion of the spacing 200 enlarges and the lower portion of the spacing 200 is reduced over that shown in FIG. 4 due to the bending of the cable portion 210 in direction 212. The bending of the stress relief portion 180 of the cable end portion 18A is limited by the stress relief portion 180 contacting the tapered surface portion 192 including the end beveled surface portion 196. By permitting controlled movement of the portion 210 of the cable end portion 18A, the fastener 42 avoids having the stress relief portion 180 bend around a smaller radius than the stress relief portion 180 can handle, which limits stress concentrations in the cable end portion 18A and improves the durability of the splice 10.

Referring to FIG. 6A, the body 80 of the fastener 42 can have a polygonal cross-sectional configuration such as the illustrated generally hexagon-shaped cross-section with outer surfaces 230 including wider flat surfaces 232, 234, 236 and narrower flat surfaces 238, 240, 242. The narrow flat surfaces 238, 240, 242 have rows of the threaded openings 86 formed therein to receive the rows 70, 72, 74 of set screws 36. Due to the presence of the set screws 36, the fasteners 40, 42 each have a larger radial dimension 243 measured from the center of the blind bore 82 to a trailing drive end 137 of each of the set screws 36 than a radial dimension 245 measured from the center of the blind bore 82 to each of the wide flat side surfaces 232, 234, 236.

The configuration of the body 80 of the fastener 42 balances competing objectives. First, the fastener 42 has a length 211 (see FIG. 4) that is as short as possible to facilitate travel of the splice 10 around a pulley while minimizing deflection or bending of the cable end portion 18A caused by the fastener 42 as the splice 10 travels around the pulley. Second, the body 80 of the fastener 42 has sufficient material at thicker portions 213, 215, 217 (see FIG. 6B) longitudinally between the threaded openings 86 of the rows 70, 72, 74 to withstand the stress in the material of the body 80 caused by the set screws 36 compressing the cable end portion 18A in the blind bore 82 and resisting pull-out of the cable end portion 18A during operation of the conveyor belt 16. More specifically, the thicker portions 213, 215, 217 have a thickness 219 between the blind bore 82 and the narrow flat surfaces 238, 240, 242 of the portions 213, 215, 217 that is sized to provide sufficient strength to resist the stress in the material of the body 80 during operation of the conveyor belt 16. The thickness 219 is greater than a thickness 221 between the blind bore 82 and wide flat surfaces 232, 234, 236 of thinner portions 223, 225, 227 of the body 80 of the fastener 42. Because the narrow portions 223, 225, 227 lack threaded set screw openings therein, the body 80 requires less material at the narrow portions 223, 225, 227 to withstand the stresses in the material of the body 80 at the narrow portions 223, 225, 227. In this manner, the greater thickness 219 of body 80 at the set screw threaded openings 86 and extending longitudinally along the rows 70, 72, 74 strengthens the body 80 and improves the durability of the faster 42 while permitting the length 211 of the fastener 42 to be minimized. In one embodiment, the fastener 42 has a length 211 of 2.588 inches, the threaded openings 86 have an inner diameter of 0.25 inches, thickness 219 is 0.135 inches, and thickness 221 is 0.069 inches.

During installation, after the fastener 42 has been secured to the cable end portion 18B, the fastener 40 is positioned on the cable end portion 18B with an orientation that is turned 60° clockwise relative to the orientation of the adjacent fastener 42. Because the fastener 40 is turned 60° clockwise relative to the fastener 42, the row 70A of set screws 36 (which includes set screw 36F) of the fastener 40 is adjacent the wide flat surface 234 of the fastener 42. Since the fastener 42 has its smaller dimension 245 associated with its surface 234 adjacent the screw row 70A of the fastener 40, the fastener 42 takes up less space near the row 70A of set screws 36 of the fastener 40 which provides clearance between the fastener 42 and the row 70A of set screws 36 of the fastener 40 while also providing a compact arrangement between the adjacent fasteners 40 and 42. Similarly, the row 74 of set screws 36 (which includes set screw 36G) of the fastener 42 is adjacent a wide flat surface 232A of the fastener 40. In this manner, the wide flat surfaces 232, 234, 236 of the fasteners 40, 42 provide clearance for the set screws 36 of the adjacent fastener 40, 42 and permit the fasteners 42, 40 to be attached to the cable end portions 18A, 18B in a tightly packed or compact arrangement. Further, the fastener 42 may be shifted in directions 73, 75 by bending the cable end portion 18A to provide clearance for the installer to connect a driver tool to the set screws 36 of rows 70A, 72A of the fastener 40.

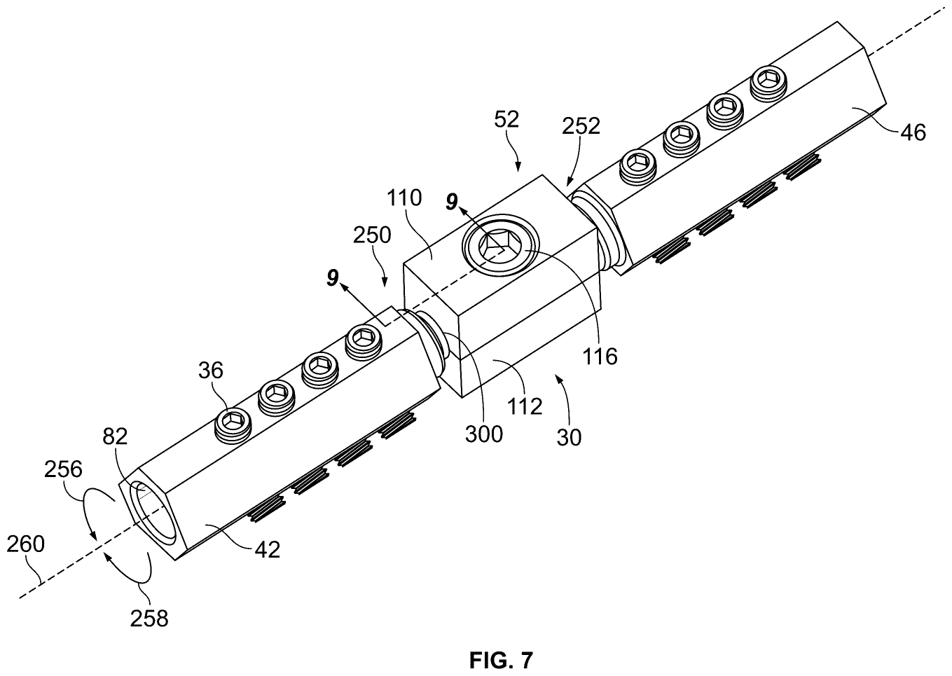

Referring to FIG. 7, the fastener assembly 30 includes rotary connections 250, 252 between the fastener 42, the connector 52, and the fastener 46. The rotary connections 250, 252 permit the fasteners to turn in opposite, rotary directions 256, 258 relative to a central axis 260 of the fastener assembly 30 during assembly of the splice 10. The ability of the fasteners 42, 46 to turn relative to the connector 52 relieves stress in the cable end portions 18, 20 that may occur due to the tightening down of the set screws 36 onto the cable end portions 18, 20. For example, the tapered leading end portions 131 of one of the set screws 36 of fastener 42 may advance into a recessed space or valley between bundles of wires of the cable end portion 18A as the set screw 36 is tightened down, which pushes the wires apart and can apply a torque to the cable end portion 18A.

Further, the rotary connections 250, 252 allow the fasteners 42, 46 to be secured to the connector 52 in any rotary orientation of the fasteners 42, 46 about the central axis 260. This makes connecting the fasteners 42, 46 to the intermediate connector 52 easier such as by allowing for the fasteners 42, 46 to turn to different rotary positions relative to the intermediate connector 52 as may be caused by tightening down of the set screws 36.

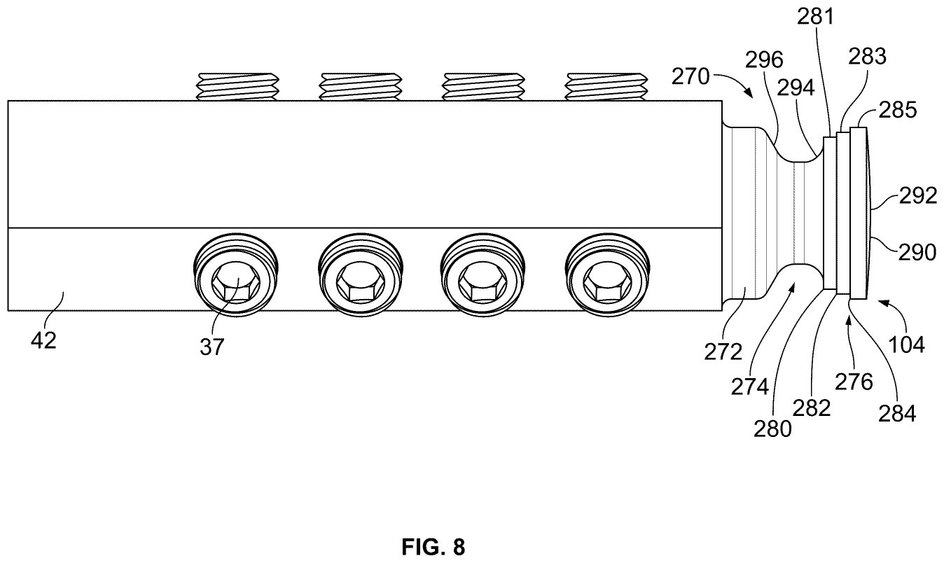

Regarding FIG. 8, the fastener 42 has an annular outboard portion 270 adjacent to the distal annular head portion 104 and having a base portion 272 and a neck portion 274 connecting the base portion 272 to the head portion 104. The head portion 104 has stop surfaces 276 that engage the stop surfaces 130 (see FIG. 3) of the connector 52 and prevent pull-out of the head portion 104 from the connector 52. The stop surfaces 276 include annular radial shoulder surfaces 280, 282, 284 that face in an inboard direction and progressively increase in diameter from the most inboard surface 280 to the most outboard surface 284. The head portion 104 has annular axial side surfaces 281, 283, 285 that extend axially from the respective annular radial surfaces 280, 282, 284 to form the stepped profile of the head portion 104.

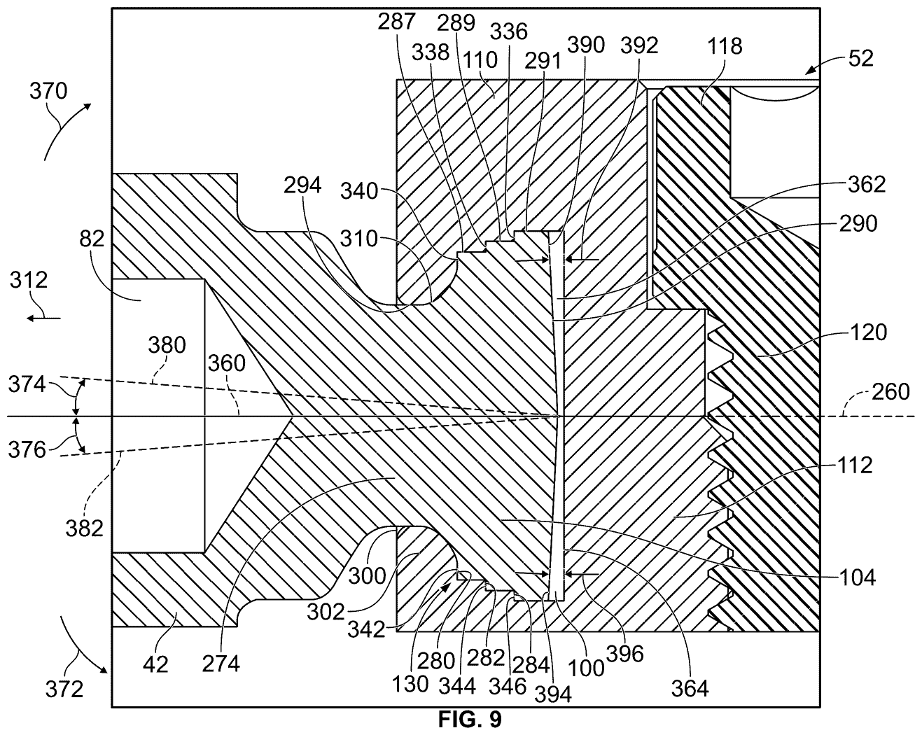

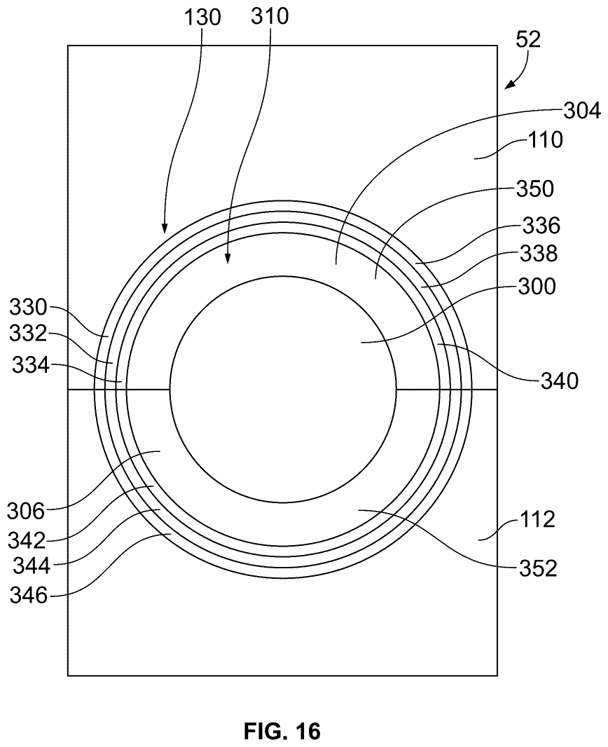

With reference to FIG. 16, the stop surfaces 130 of the connector 52 include annular stop shoulder surfaces 330, 332, 334 that progressively decrease in diameter from the most outboard surface 330 to the most inboard surface 334. The annular radial shoulder surfaces 280, 282, 284 of the fastener head portion 104 and the annular stop surfaces 330, 332, 334 of the connector 52 are flat and in confronting facing relation to keep the head portion 104 from wedging apart the upper and lower connector members 110, 112 when the splice 10 is tensioned and the fastener 42 is urged in inboard direction 312 (see FIG. 9) during operation of the conveyor belt 16.

The rotary connection 250 of FIG. 7 is provided by the annular radial surfaces 280, 282, 284 (see FIG. 8) and the axial side surfaces 281, 283, 285 of the head portion 104 being sized and configured to allow them to slide along and turn relative to the corresponding adjacent ones of the annular stop surface portions 330, 332, 334 (see FIG. 16) and annular axial side surfaces 287, 289, 291 of the connector 52 before the head portion 104 is pulled tightly against the connector 52 by tension in the cable end portions 18A, 20A. Stated differently, during installation of the splice 10, the head portion 104 has the above-described annular surfaces that can turn relative to the corresponding, adjacent or facing annular surfaces of the connector 52 when the head portion 104 is received in the connector 52 and before tension is applied to the cable end portions 18A, 20A.

With reference to FIG. 8, the connector pockets 100, 102 are sized and configured and the head portion 104, base portion 272, and neck portion 274 of the fasteners 42, 46 are sized and configured to permit controlled rocking of the fastener 42 in directions 370, 372 (see FIG. 9) relative to the connector 52 as the splice 10 travels around a pulley.

The head portion 104, neck portion 274, and base portion 272 have annular cross-sections that permit pivoting or rocking of the fastener 42 relative to the connector 52 at any rotary orientation of the fastener 42 relative to the connector 52.

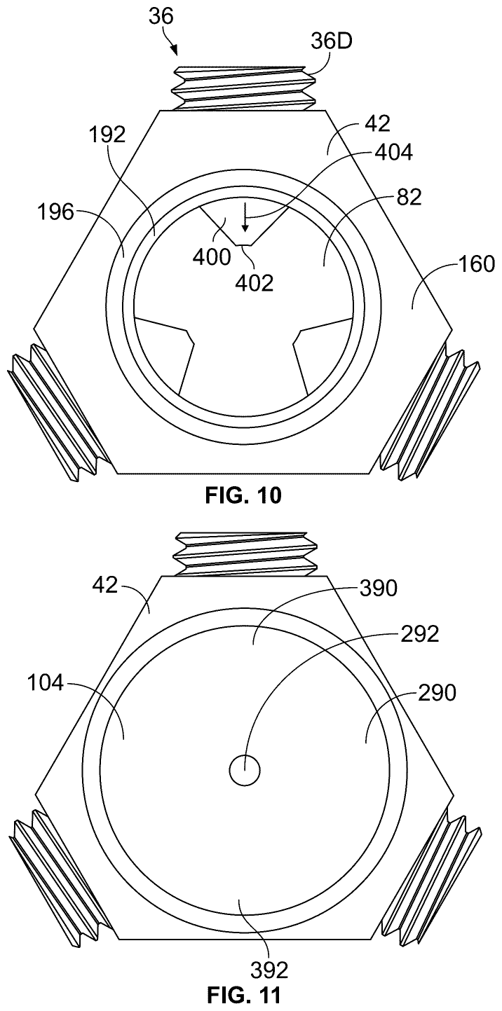

As shown in FIGS. 8 and 11, the head portion 104 includes a conical leading surface 290 and a small end flat 292 to provide clearance for pivoting or rocking in the connector pocket 100. The neck portion 274 has a concave annular neck surface portion 294 with an outer diameter that decreases as the neck portion 274 extends outboard away from the base portion 272 and inboard from the head portion 104 to a minimum outer diameter thereof approximately halfway between the base portion 272 and the head portion 104. The concave neck surface portion 294 is configured to rock in directions 370, 372 about an annular convex neck-down surface portion 310 of the connector 52.

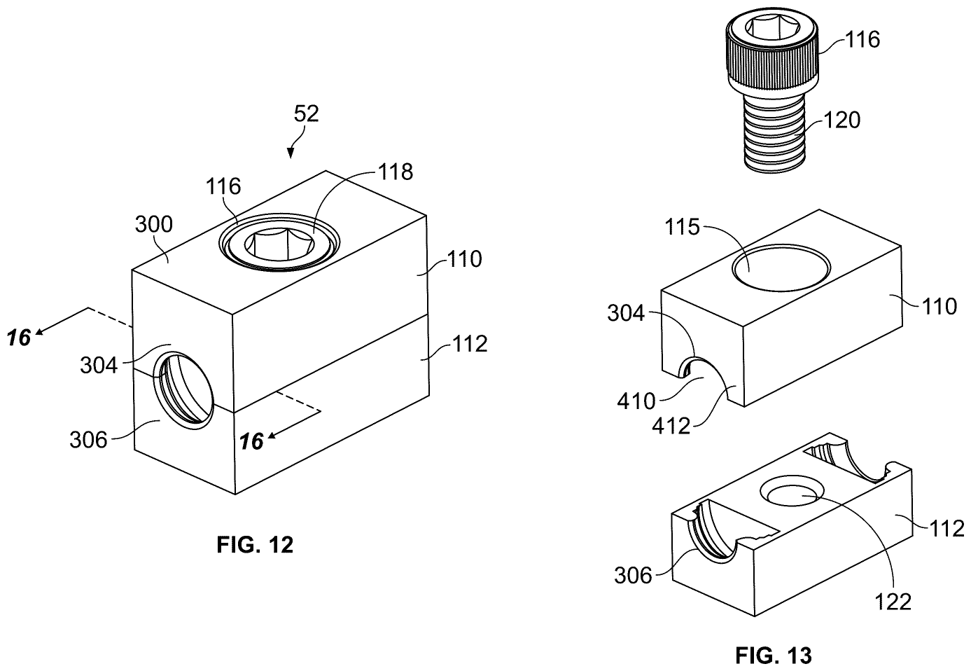

Referring to FIG. 9, the head portion 104 of the fastener 42 is shown received in the connector pocket 100 captured between the secured together upper and lower connector members 110, 112. The connector 52 has a connector end entry opening 300 that opens to the connector pocket 100 and receives the neck portion 274 of the fastener 42. The connector 52 has a narrowed or neck down annular portion 302 formed by cooperating semicircular rim portions 304, 306 (see FIG. 12) of the upper and lower connector members 110, 112. The rim portions 304, 306 each include half of the convex neck-down surface portion 310. The concave neck surface portion 294 of the fastener 42 is tightly urged against the convex neck-down surface portion 310 of the connector 52 in direction 312 due to tension in the splice 10 during operation of the conveyor belt 16. In this manner, some of the axial loading caused by the tension in the conveyor belt 16 is transferred between the fastener 42 and connector 52 via the tightly engaged concave neck surface portion 294 and convex neck down surface portion 310.

As previously discussed, the stop surfaces 130 of the connector 52 include the annular stop shoulder surfaces 330, 332, 334 as shown in FIG. 16. The annular stop shoulder surfaces 330, 332, 334 are formed by semicircular stop surface portions 336, 338, 340 of the upper connector member 110 that are radially co-planar with respective semicircular stop surface portions 342, 344, 346 of the lower connector member 112 when the upper and lower connector members 110, 112 are assembled. The annular stop shoulder surfaces 330, 332, 334 progressively decrease in diameter from the most radially outer annular stop shoulder surface 330 to the most radially inner annular stop shoulder surface 334. Likewise, the convex neck-down surface portion 310 of the connector 52 is formed by semicircular convex neck-down surface portions 350, 352 of the rim portions 304, 306 of the upper connector member 110 and the lower connector member 112.

Returning to FIG. 9, the blind bore 82 of the fastener 42 has a central axis 360 that is shown as being coaxial with the central axis 260 of the fastener assembly 30. The conical leading surface 290 of the fastener 42 has a spacing or gap 362 from an internal, flat end surface 364 of the pocket 100 when the cable end portions 18A, 20A are under tension with the fastener surface portion 294 engaged with the connector surface portion 310 during conveyor belt operation, as shown. The head portion 104, neck portion 274, and pocket 100 are configured to permit the fastener 42 to rock in directions 370, 372 and move the central axis 360 to positions 380, 382 at angles 374, 376 from the initial position of the central axis 360. In one embodiment, the head portion 104, neck portion 274, and pocket 100 limit each of the angles 374, 376 to a maximum value of approximately 2°.

In the above-described tensioned configuration, the conical leading surface 290 has an upper portion 390 that has a varying distance 392 from the end surface 364 and a lower portion 394 that has a similarly varying distance 396 from the end surface 364. The distances 392, 396 gradually increase in a radial outward direction from the center of the end surface 364 due to the conical configuration of the fastener leading surface 290. Accordingly, when the fastener 42 rocks in direction 372, the distance 396 decreases and the distance 392 increases. Conversely, when the fastener 42 rocks in direction 370, the distance 396 increases and the distance 392 decreases.

The fastener 42 is shown in FIG. 9 in a typical tensioned configuration when the splice 10 is under tension loads wherein the central axis 360 of the blind bore 82 is coaxial with the central axis 260 of the fastener assembly 30. In the typical configuration, the entirety or 360 degrees of each of the annular radial surfaces 280, 282, 284 of the fastener head portion 104 is in flush engagement with the entirety of the corresponding annular stop surface portions 330, 332, 334 of the connector pocket 100. When the fastener 42 has rocked in either direction 370 or 372 from the initial position, less than the entirety of each of the annular radial surfaces 280, 282, 284 is in engagement with the corresponding annular stop surface portions 330, 332, 334. The ability of the fastener 42 to rock in directions 370, 372 permits the fastener assembly 30 to relieve tension in the fastener assembly 30 as the splice 10 travels around a pulley.

Regarding FIG. 10, the fastener 42 is shown with the set screws 36 advanced into the blind bore 82. Regarding the set screw 36D, the set screw 36D is a pointed tip set screw having a frustoconical leading side surface 400 that imparts a sideways wedging force to the wires of the cable and a leading surface 402 for advancing into gaps between bundles of wires of the cable. The set screws 36 are turned using a driver, such as with an impact driver having a bit, that engages a rotary drive structure such as a hexagonal drive socket 37 (see FIG. 8) of the set screws 36. The set screws 36 advance radially inward into the blind bore 82 in direction 404 with tightening down of the set screws 36. The filler 19 (see FIG. 3), such as urethane, inhibits loosening of the set screws 36 once the splice 10 has been installed.

Regarding FIG. 12, the assembled intermediate connector 52 is shown disconnected from the fasteners 42, 46. The socket head screw 116 secures the connector members 110, 112 together and the filler 19 inhibits loosening of the socket head screw 116. The connector members 110, 112 resist separation of the fasteners 42, 46 (see FIG. 3) and are under tension during operation of the conveyor belt 16. The socket head screw 116 is thereby subjected to much lower loads as the tension of the conveyor belt 16 will mainly act longitudinally which is taken up by the fasteners 42, 46 and the connector members 110, 112 rather than the socket head screw 116. The socket head screw 116 applies sufficient compressive force to the connector members 110, 112 to keep the head portions 104, 106 of the fasteners 42, 46 captured within the pockets 100, 102 of the connector 52.

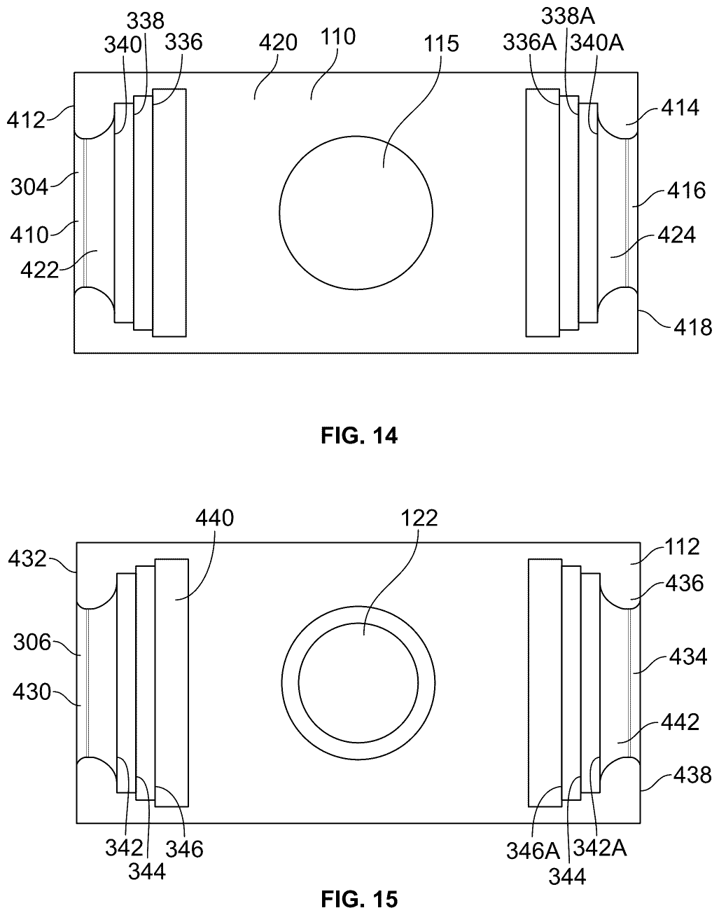

Turning to FIG. 13, the connector 52 is shown in an exploded view with the socket head screw 116 removed from the countersunk opening 115 and bore 122 of the connector members 110 and 112, respectively. Regarding FIGS. 13 and 14, it can be seen that the semicircular rim portion 304 of the upper connector member 110 extends along concave recessed opening 410 in one end 412 of the upper connector member 110 and the upper connector member 110 has a corresponding semicircular rim portion 414 extending along concave recessed opening 416 at an opposite end 418 of the upper connector member 110. The upper connector member 110 has a lower surface 420 with recessed pocket portions 422, 424 formed therein that are in communication with the respective openings 410, 416. Likewise, as can be seen in FIG. 15, the lower connector member 112 has an opening 430 along which the semicircular rim portion 306 extends at end 432 and opening 434 along which semicircular rim portion 436 extends at the opposite end 438. The lower connector member 110 has recessed pocket portions 440, 442 that are in communication with the respective openings 430, 434.

Regarding FIGS. 14 and 15, the recessed pocket portions 424, 442 have semi-circular stop surface portions 340A, 338A, 336A and 342A, 344A, 346A that may be identical to the previously-described stop surface portions of the recessed pocket portions 422, 440. In this manner, the semi-circular stop surface portions of the recessed pocket portion 422 and recessed pocket portion 440 cooperate to form the previously-described annular stop shoulder surfaces 330, 332, 334 that engage and inhibit pullout of the head portion 104 of the fastener 42 (see FIG. 16) while the stop surface portions 340A, 338A, 336A and 342A, 344A, 346A of the recessed pocket portions 424, 442 cooperate to engage and inhibit pullout of the head portion 106 of the fastener 46. Further, the identical arrangement of the stop surface portions of the recessed pocket portions 422, 440 and 424, 442 permit the connector 52 to be arranged with either recessed pocket portions 422, 440 or recessed pocket portions 424, 442 receiving either of the fastener head portions 104, 106 which makes installation easier. In other words, the connector 50 (see FIG. 2) may be oriented so that either end 50A, 50B of the connector 50 may be attached to one of the upstream fasteners 32 and the opposite end 50A, 50B attached to the corresponding downstream fastener 34.

Referring back to FIG. 1, in one embodiment, the splice 10 includes an additional body such as a slab or sheet 35A that an installer positions above the cable end portions 18, 20 and before applying the filler 19 to reduce the volume of filler 19 used to form the splice 10. The sheet 35A may be made of, for example, rubber or urethane. The sheet 35A has openings 37 to permit the filler 19 to flow through the sheet 35A and form engaged portions of the filler 19 and sheet 35A which secures the sheet 35A to the filler 19.

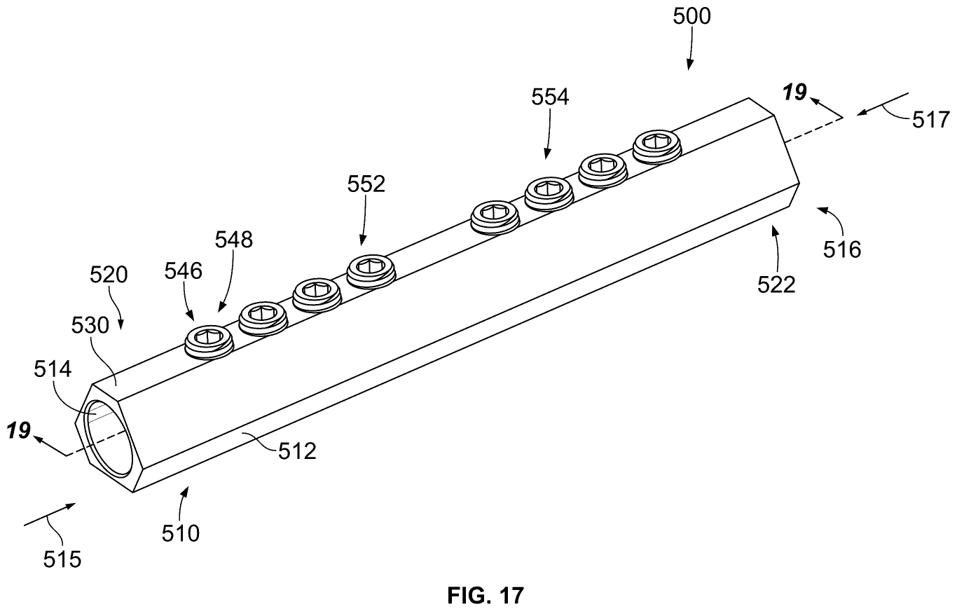

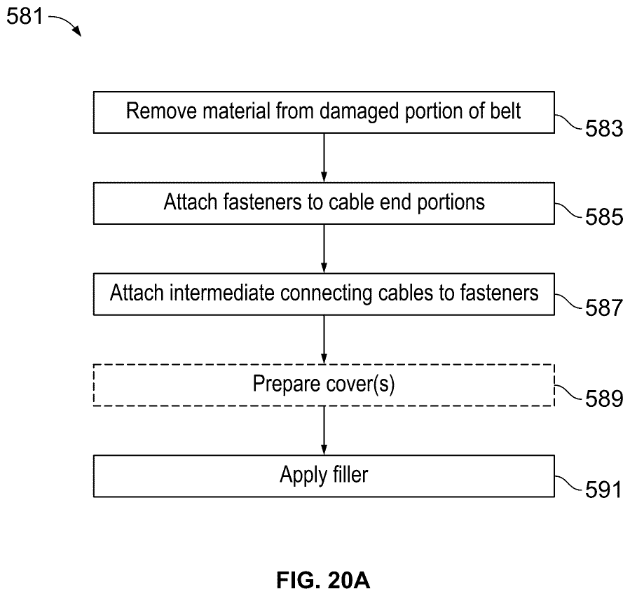

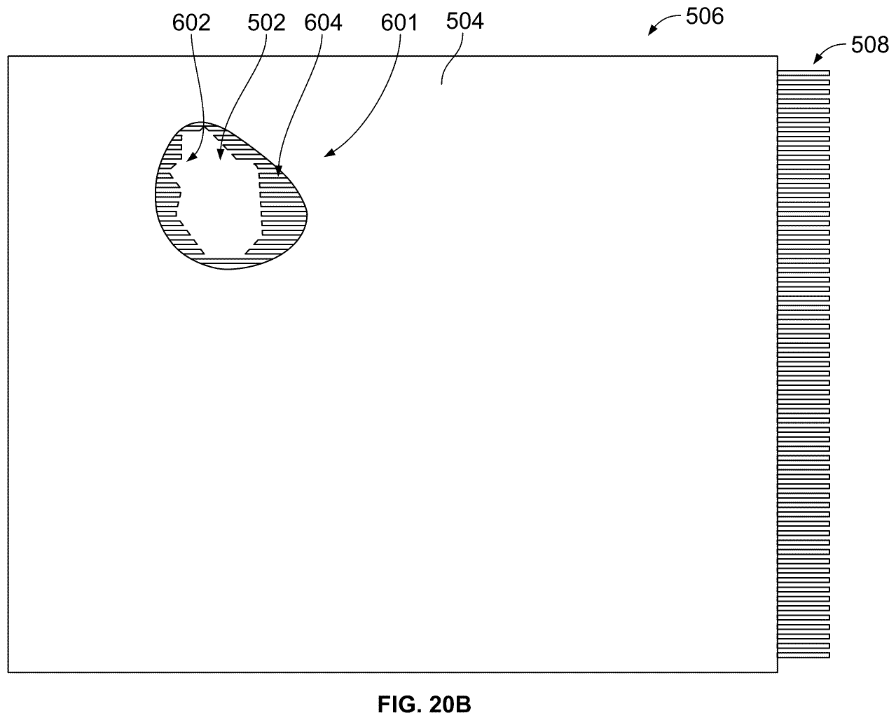

Turning to FIG. 17, an alternative fastener 500 is provided that may be used to repair more minor belt damage, such as a hole 502 (see FIG. 20B), in a conveyor belt 506 having cables 508 rather than having to undertake the time and effort to install a complete splice between cut and prepared belt ends, such as above-described splice 10. The fastener 500 includes a body 510 having a tubular side wall 512 and end portions 520, 522. The tubular side wall 512 extends about blind bores 514, 516 of the body 510. The bores 514, 516 are sized to receive cable end portions advanced in directions 515, 517 into the bores 514, 516. The fastener 500 has set screws 548 for securing the cable end portions in the bores 514, 516.

The fastener 500 has a row 546 of set screws 548 received in a corresponding row of threaded openings 550 (see FIG. 19) in the side wall 512 along the length of the body 510. The set screws 548 include a first group 552 of the set screws 548 for engaging a first cable end portion in the bore 514 and a second set 554 of set screws 548 for engaging the cable end portion received in the bore 516.

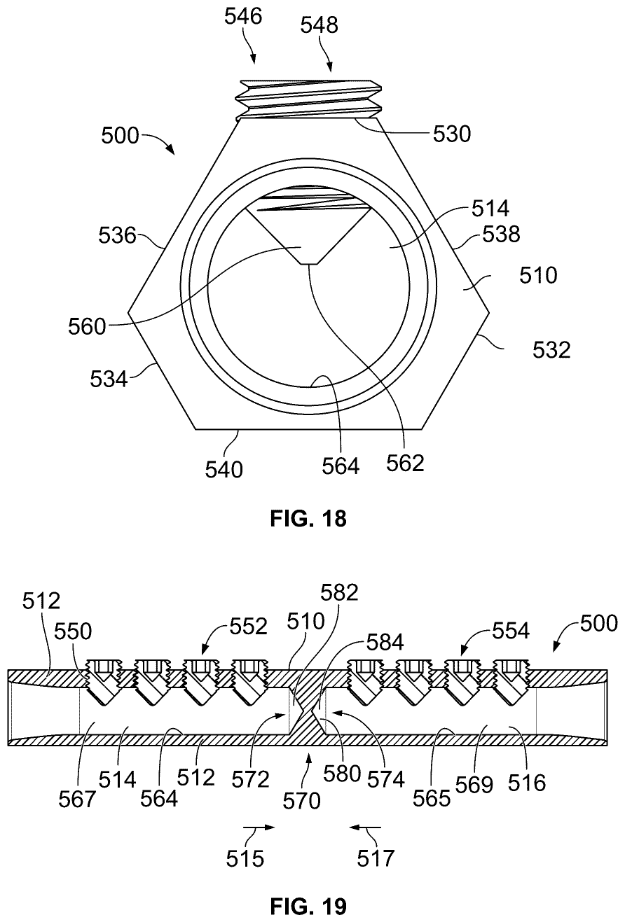

Regarding FIG. 18, the body 510 can have a polygonal cross-sectional configuration such as the illustrated generally hexagonal cross-sectional configuration similar to the body 80 of the fastener 42 discussed above. The body 510 has narrow flat surfaces 530, 532, 534 and wide flat surfaces 536, 538, 540. The hexagonal shape of the body 510 of the fastener 500 permits the fasteners 500 to be installed side-by-side on cables of a belt without the fasteners 500 contacting one another.

The row 546 of set screws 548 protrude from the narrow flat surface 530 of the body 510. The set screws 548 each have a frustoconical side surface 560 and a flat leading surface 562. The set screws 548 secure the cable end portions in the bores 514, 516 by disrupting the wires of the cable end portions and by clamping the cable end portions against lower surface portions 564, 565 of inner surfaces 567, 569 (see FIG. 19) of the bores 514, 516.

Regarding FIG. 19, the fastener 500 has an intermediate portion 570 with stops 572, 574 to limit movement of the cable end portions in directions 515, 517 into the bores 514, 516. In one embodiment, the intermediate portion 570 includes a wall 580 and the stops 572, 574 include annular surfaces 582, 584 of the wall 580 that may be conical or flat to contact free ends of the cable end portions received in the bores 514, 516.

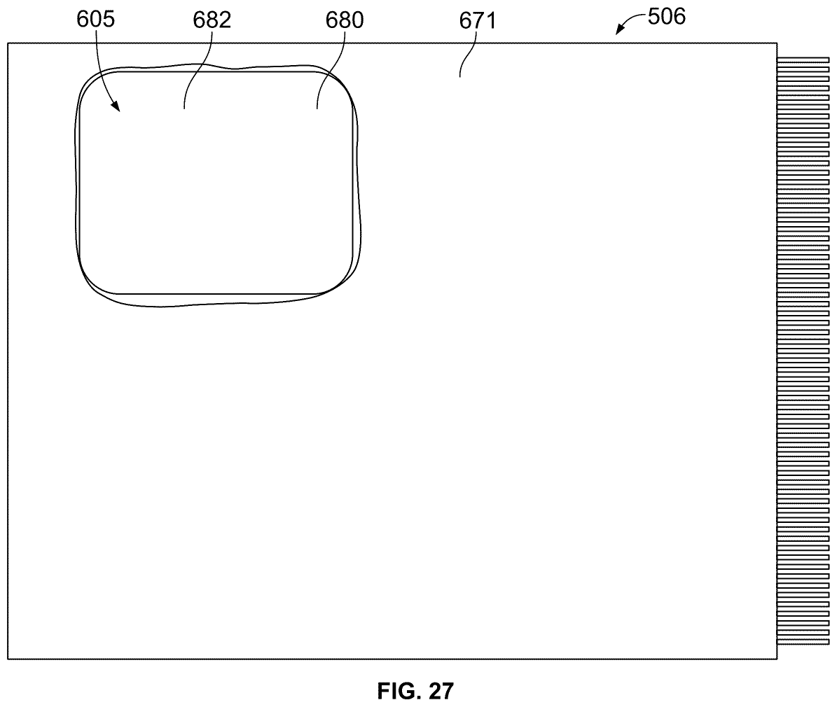

Next, reference will be had to FIGS. 20A-27 that illustrate a method 581 for repairing a damaged portion 601, such as the hole 502, of the conveyor belt 506. The method 581 involves installing a patch 605 (see FIG. 27) that covers the hole 502 and facilitates continued use of the conveyor belt 506 without replacing the conveyor belt 506 or cutting and splicing the conveyor belt 506 such as with the previously-described splice 10. The patch 605 obstructs the hole 502, protects the cables 508, and keeps the hole 502 from enlarging.

The conveyor belt 506 has upper and lower covers 504, 505 (see FIG. 25) and a body 600 therebetween. The upper cover 504, body 600, and lower cover 505 may be made of different types of rubber. For example, the upper cover 504 may be made of a first rubber having a higher abrasion resistance, the body 600 may be made of a second rubber that facilitates vulcanization and engagement with the cables 612A-612C, 660, 662, and the bottom cover 505 may be made of a third rubber that has a low rolling resistance. The hole 502 may extend through the upper cover 504, body 600, and lower cover 505. The hole 502 may be due to, for example, a puncture in the conveyor belt 506 caused by a sharp object, such as a piece of aggregate, falling onto the conveyor belt 506 or multiple pieces of aggregate repeatedly falling onto the same location of the conveyor belt. The hole 502 includes damaged cable end portions 602, 604 of the cables 508 at generally opposite sides of the hole 502. The wires of the damaged cable end portions 602, 604 may be intertwined with the wires of adjacent cables and form a randomly oriented bunch of cable wires in and projecting from the hole 502.

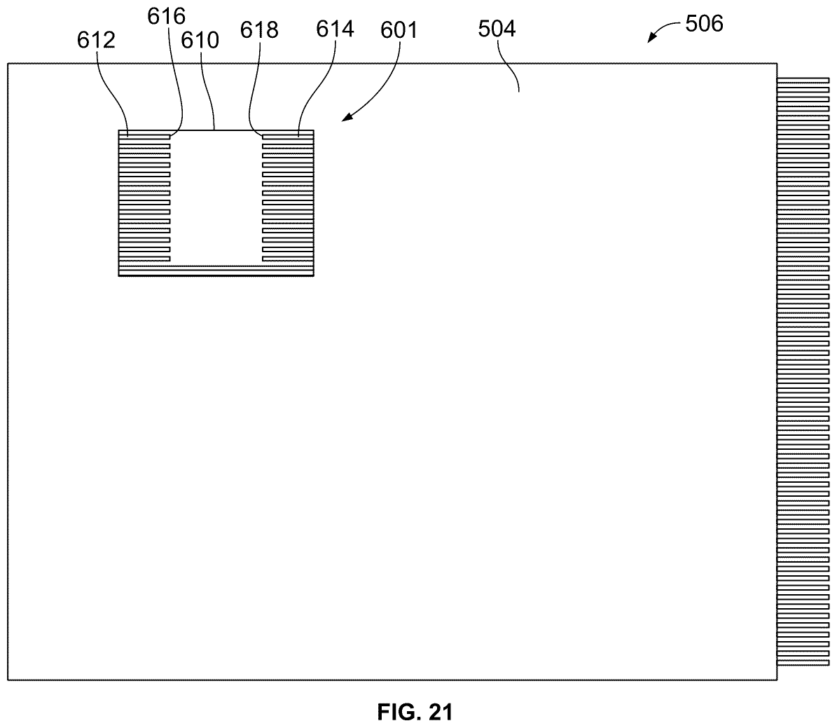

Referring to FIG. 21, the method 581 includes, at step 603, trimming away or removing portions of the cover 504 and the body 600 of the conveyor belt 506 from the damaged portions 601 to form an enlarged opening 610 over the original opening or hole 502. The damaged cable end portions 602, 604 are cut to provide trimmed cable end portions 612, 614 having ends 616, 618 that are laterally aligned with the other trimmed cable end portions 612, 614 across the conveyor belt 506.

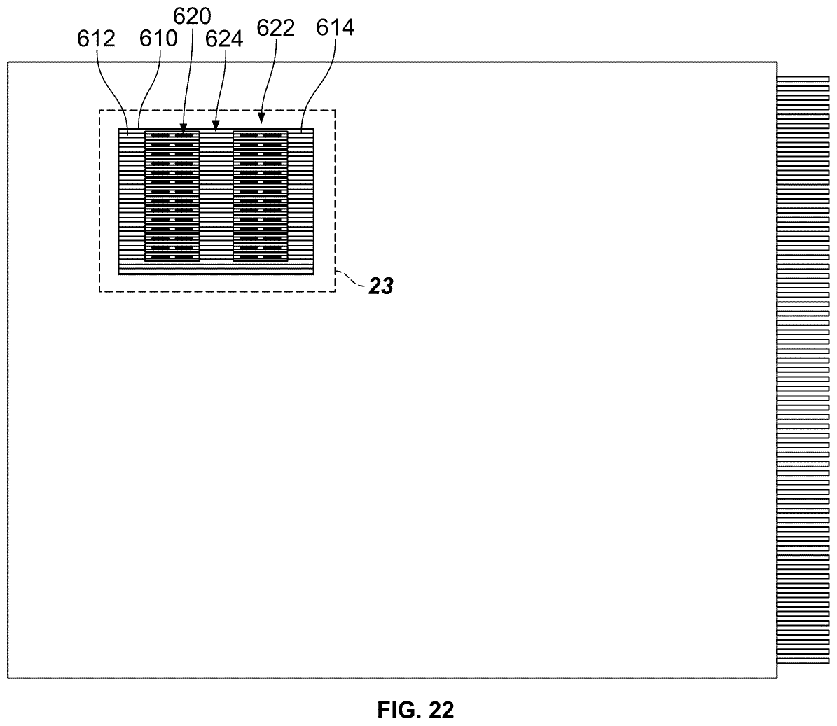

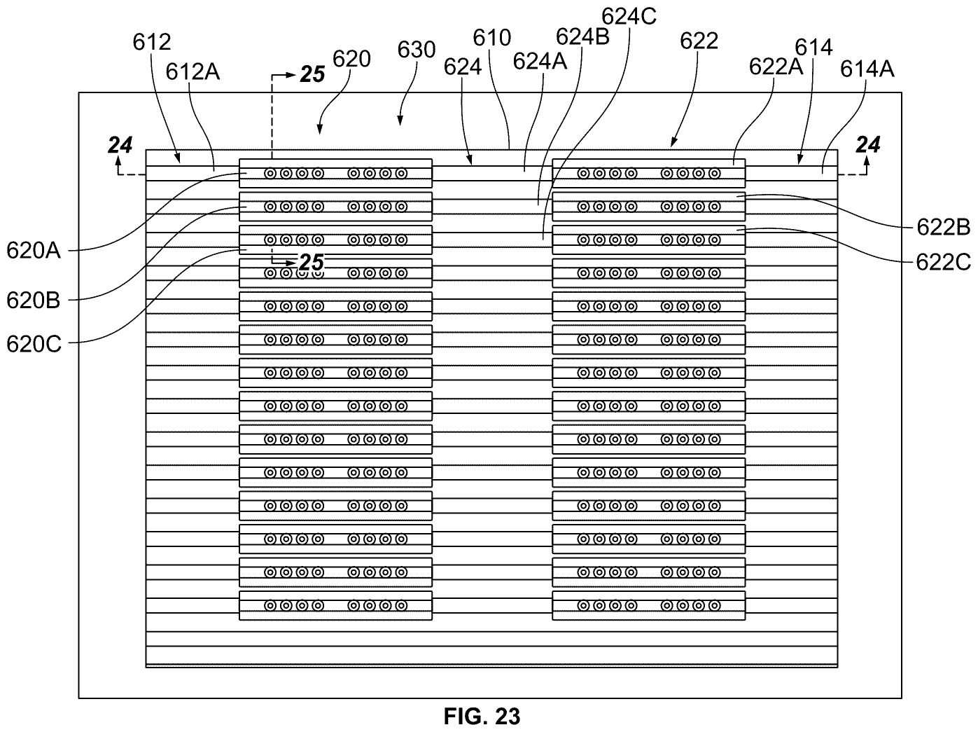

The method 581 at step 585 next includes attaching fasteners 620, 622 to the trimmed cable end portions 612, 614, as shown in FIGS. 22 and 23. The fasteners 620, 622 are each similar to the fastener 500 of FIG. 17. Referring specifically to FIG. 23, the fasteners 620 include fasteners 620A, 620B, 620C and the fasteners 622 include fasteners 622A, 622B, 622C.

At step 587, the method 581 further includes securing intermediate connecting cables 624 to the fasteners 620, 622. The connecting cables 624 include connecting cables 624A, 624B, 624C, as shown in FIG. 23. The assemblies of the fasteners 620, 622 and connecting cables 624 connect the trimmed cable end portions 612, 614 and form a patch support 630 that extends across the enlarged opening 610. The patch support 630 provides structure that filler 680 (see FIG. 27) can attach to as part of filling the enlarged opening 610. The connecting cables 624 may be the same or different than the cables 508.

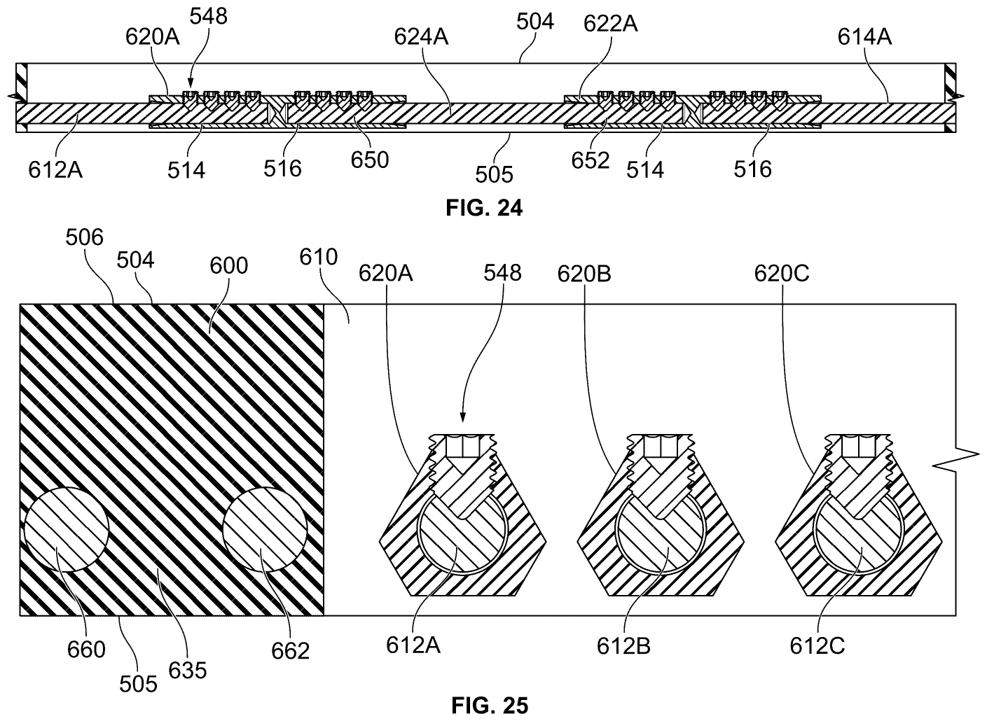

Regarding FIG. 24, the fasteners 620A, 622A are shown with the bores 514, 516 thereof receiving the cable end portions 612A, 614A as well as end portions 650, 652 of the connector cable 624A. The set screws 548 have been tightened down to secure the fasteners 620A, 622A to the cable end portions 612A, 614A and the connector cable 624A.

Regarding FIG. 25, the conveyor belt 506 is shown with cables 660, 662 embedded in an undamaged portion 635 of the body 600. The cable end portions 612A, 612B, 612C extend across a portion of the enlarged opening 610 and are secured to the fasteners 620A, 620B, 620C.

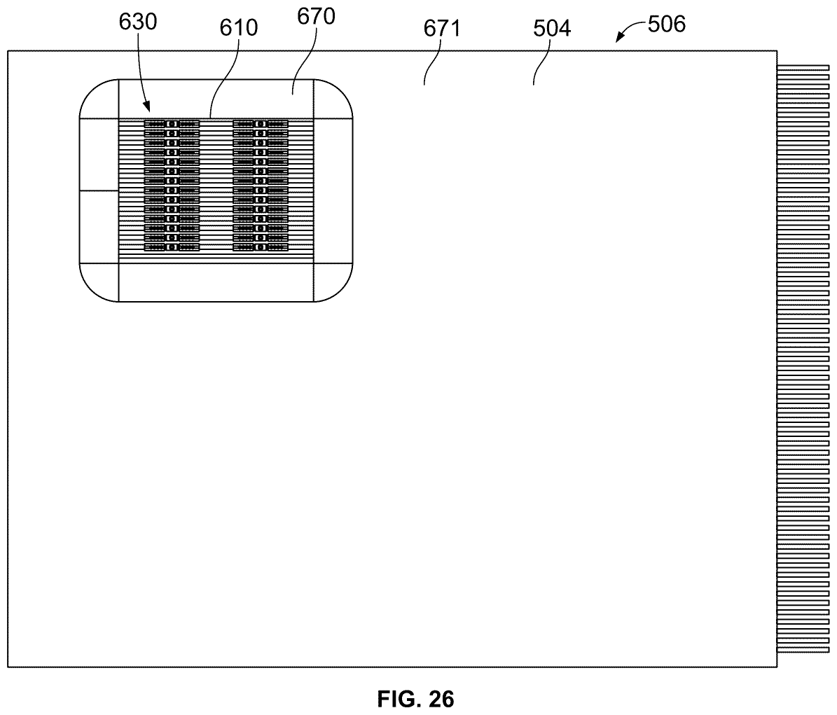

The patch support 630 is then installed in the opening 610, as shown in FIG. 26. The method 581 at step 589 optionally includes removing material of the cover 504 around the opening 610 to form a recessed portion 670 in the cover 504 that extends around the opening 610. The recessed portion 670 provides increased surface area of the cover 504 for engagement by the filler 680 while permitting the filler 680 to be flush with the uppermost surface 671 of the upper cover 504.

At step 591, the method 81 includes applying the filler 680 to cover the recessed portion 670 and fill the enlarged opening 610. The filler 680 may include, for example, a urethane. A backing, such as duct tape or a plastic material may be applied across the underside of the conveyor belt 506 during the filling operation to keep the filler 680 from flowing out of the opening 610. Once the filler 680 has cured, the filler 680 has an upper surface 682 that is level or flush with the uppermost surface 671 of the conveyor belt 506. The upper surface 682 of the filler 680 can support conveyed material. Further, the filler 680 obstructs the enlarged opening 610 and prevents objects from catching on or otherwise further damaging the conveyor belt 506.

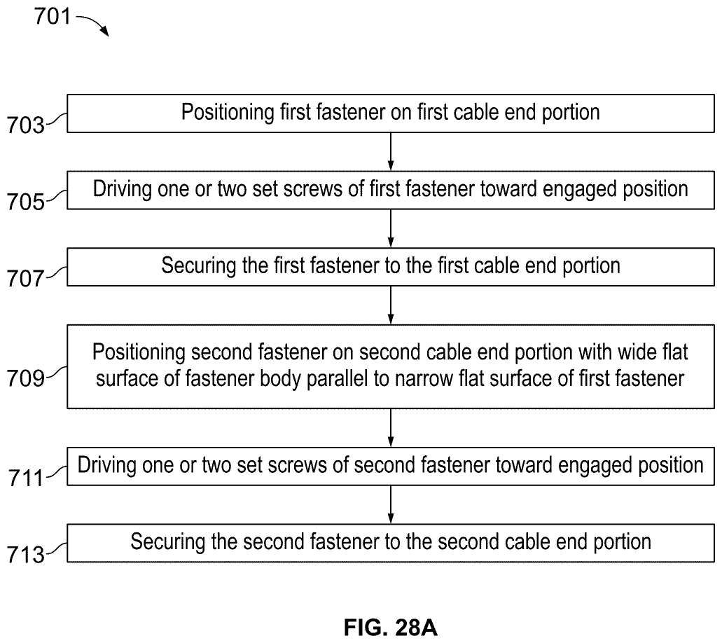

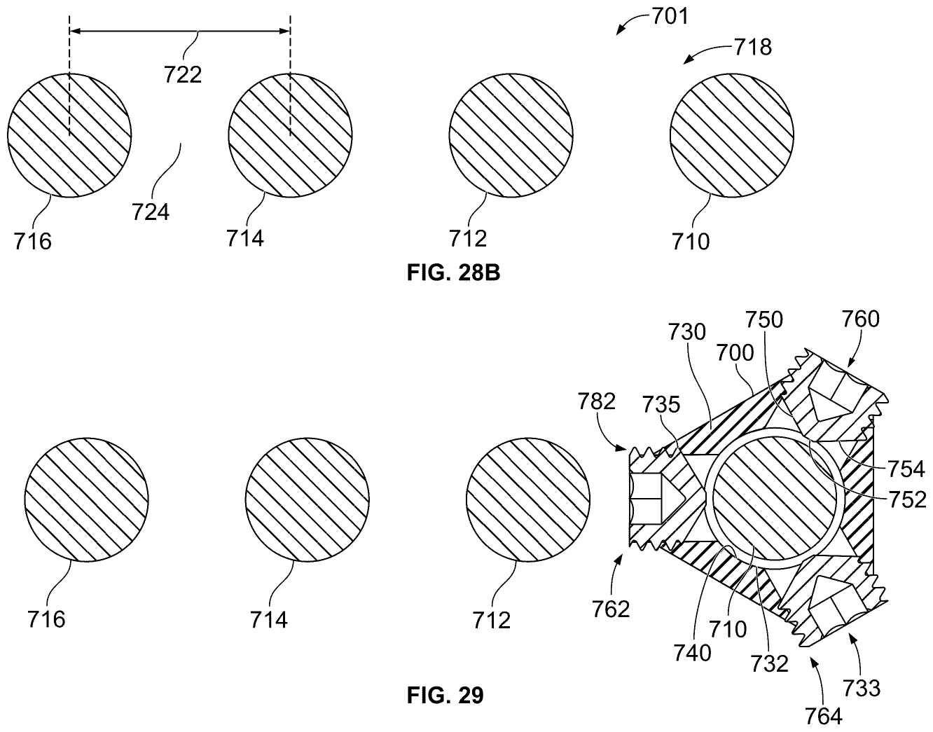

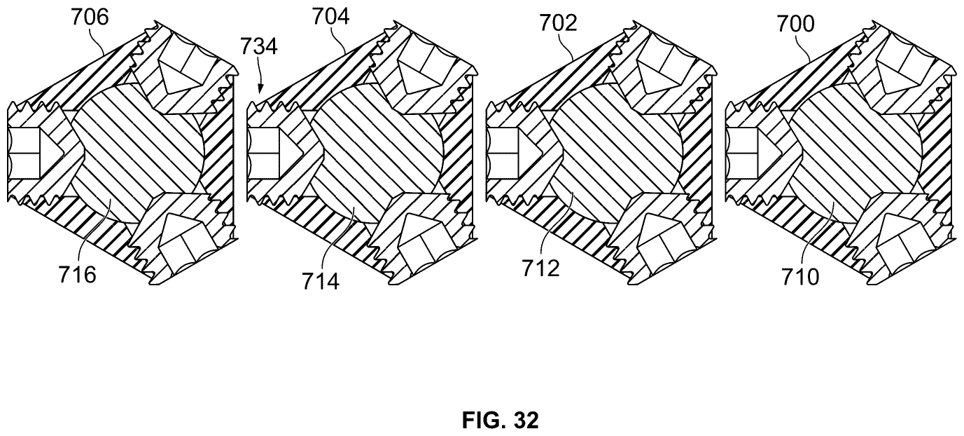

With reference to FIGS. 28A-32, a method 701 is provided for securing fasteners 700, 702, 704, 706 (FIG. 32) to cable end portions 710, 712, 714, 716 (FIG. 28B) of a conveyor belt end. The fasteners 700, 702, 704, 706 are similar to the upstream fasteners 32 and downstream fasteners 34 discussed above. With reference to FIG. 29, the fastener 700 includes a body 730 with a blind bore 732 that receives the cable end portion 710. The fastener body 730 has narrow flat surfaces 782, 772, 792 similar to the narrow flat surfaces 238, 240, 242 (see FIG. 6A) of the fastener 42 discussed above. The fastener 700 has rows 760, 762, 764 of set screws 733 threadingly engaged with corresponding rows of threaded set screw openings 735 of the body 730. The set screws 733 each have a leading end portion 750 with a flat leading surface 752 and a frustoconical side surface 754. The trailing end portion of the set screws 733 of row 760 protrude from a narrow flat surface 782 of the body 730.

The cable end portions 710, 712, 714, 716 each have a predetermined pitch 722 between the centers of adjacent cable end portions 710, 712, 714, 716, as shown in FIG. 28B. The pitch 722 provides a lateral spacing 724 between the cable end portions 710, 712, 714, 716. The pitch 722 may be, for example, 14.5 mm and the diameter of the cable end portions 710, 712, 714, 716 may be 7.6 mm.

The method 701 includes positioning 703 the fastener 700 on the cable end portion 710 so that the cable end portion 710 is received in bore 732. The step of positioning 703 includes setting a longitudinal position of the fastener 700 along the cable end portion 710 by advancing the fastener 700 in an inboard or proximal direction along the cable end portion 710 until an inboard or proximate end of the fastener 700 abuts a stop, such as an angle iron having a leg portion extending laterally or orthogonally across the cable end portions 710-716. The step of positioning 703 also includes setting a rotary position of the fastener 700 by turning the fastener 700 to orient one of the narrow flat surfaces such as the illustrated narrow flat surface 782 of the body 730 facing the adjacent cable end portion 712 to extend vertically.

The method 701 includes driving 705 one or two set screws 733 to set the longitudinal and rotary positions of the fastener 700 on the cable end portion 710. The step of driving 705 the one or two set screws 733 includes having the installer shift or advance one or two of the set screws 733 to an engaged position, such as by tightening down the set screw(s) 733, to engage and temporarily secure the fastener 700 to the cable end portion 710 so that the installer can double-check the longitudinal position and rotary orientation of the fastener 700 on the cable end portion 710. The installer can loosen the one or two set screws 733 and reposition the fastener 700 if needed.

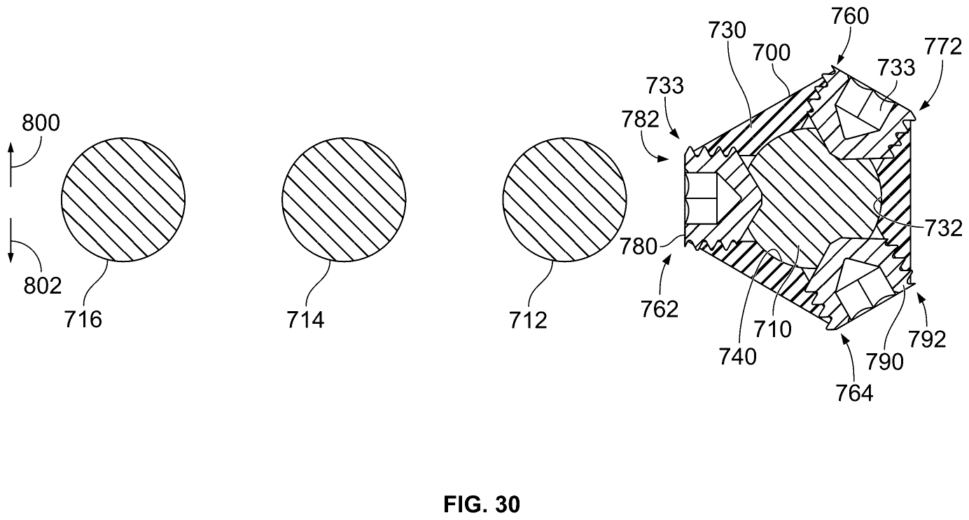

Once the installer is satisfied with the position of the fastener 700 on the cable end portion 710, the method 701 includes securing 707 the fastener 700 to the cable end portion 710. The step of securing 707 includes having the installer drive the rest of the set screws 733 of the fastener 700 to their final advanced or installed positions to secure the fastener 700 to the cable end portion 710. The driving or shifting of the set screws 733 to the final advanced positions thereof reconfigures the set screws 733 from the initial configuration of FIG. 29 to a secured configuration of FIG. 30 further radially inward than when in the initial, engaged portion of the set screws 733. The installer may shift the rest of the set screws 733 to the engaged positions using a driver tool, such as an Allen wrench or a powered tool, to engage and tighten down the set screws 733. In one approach, the driver tool is a powered tool having a clutch configured to keep the driver tool from applying torque to the set screw 733 beyond a predetermined torque.

For example, the installer tightens down the set screws 733 of the row 762, followed by the set screws 733 of the rows 760 and 764. For this purpose, the installer may shift or bend the cable end portion 712 in direction 800 upwardly or direction 802 downwardly to provide sufficient clearance for connecting a driving tool to the set screws 733 of the row 762. In this manner, the set screws 733 of row 762 may be accessed and tightened down without interference from a fastener on the cable end portion 712 which makes tightening down of the set screws 733 of the row 762 easier.

Referencing FIG. 30, the installer advances the set screws 733 of the rows 760, 762, 764 radially inward toward the cable end portion 710 in the blind bore 732 until a trailing end surface 780 of each of the set screws 733 is flush with, or slightly above, the associated narrow flat surface 782, 772, 792 of the fastener body 730. Each of the set screws 733 of the rows 760, 762, 764 deform the wires of the cable end portion 710 in a similar manner, including compressing the cable end portion 710 against an annular inner surface 740 of the blind bore 732 and separating and splaying the wires of the cable end portion 710 with the leading end portion 750 driven therebetween.

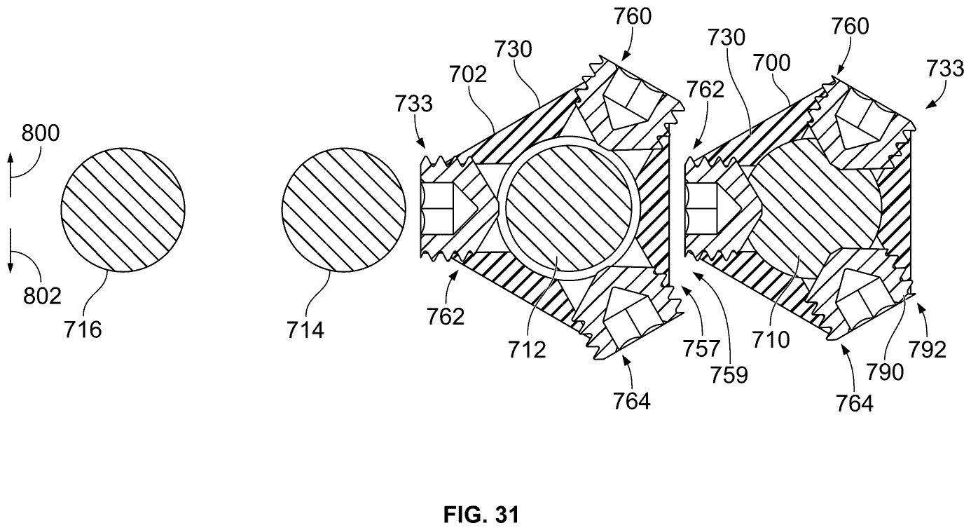

The method 701 includes positioning 709 the next fastener 702 on the cable end portion 712 once the fastener 700 has been secured to the cable end portion 710 (see FIG. 30). The step 709 includes having the installer position the next fastener 702 on the cable end portion 712 in a similar manner as done with fastener 700, as shown in FIG. 31. The body 730 of the fastener 702 has a wide flat surface 757 spaced by a gap 759 from the row 762 of set screws 733 of the fastener 700. The step 709 includes rotationally orienting the fastener 702 so that the wide flat surface 757 of the fastener 702 extends parallel to a narrow flat surface of the fastener 700 associated with the row 762 of set screws 733 of the fastener 700. Because the row 762 of set screws 733 of the fastener 700 have been shifted to the final advanced positions thereof prior to positioning the fastener 702 on the cable end portion 712, the installer is able to secure the fastener 700 to the cable end portion 710 despite the close proximity of the wide flat surface 757 of the fastener 702 to the row 762 of set screws 733 of the fastener 700.

The installer sets the longitudinal position of the fastener 702 on the cable end portion 712 and the rotary orientation of the fastener 702 in a manner similar to the approach discussed above with respect to fastener 700. At step 711, the installer shifts one or two of the set screws 733 of the fastener 702 to the initial engaged position to temporarily secure the fastener 702 on the cable end portion 712, confirms the positioning of the fastener 702, then shifts the remaining set screws 733 to the final more radially advanced positions thereof at step 713. The installer may shift the cable end portion 714 in direction 800 or direction 802 to provide clearance for a driver tool as the installer uses the driver tool to drive the set screws 733 of the row 762 to the final advanced positions thereof. Further, the rows 760, 764 of set screws 733 of the fastener 702 are accessible without interference from the fastener 700 due to the rows 760, 764 of the fastener 702 being positioned above and below the row 762 of the fastener 700. Thus, the installer, while having the option to shift the cable end portion 714 in direction 800 or direction 802 for driving the rows 760, 764 of set screws 733 to their final advanced positions, they do not necessarily need to do so.

Once the installer secures the fastener 702 to the cable end portion 712, the installer sequentially secures the fasteners 704 and 706 to the cable end portions 714, 716 in a manner similar to the approach discussed above with respect to fasteners 700, 702. Regarding FIG. 32, the fasteners 700-706 are shown secured to the cable end portions 710-716. The installer installs fasteners 700-706 on the conveyor belt end portions 710-714 progressing sequentially in a right-to-left manner from the perspective of FIGS. 28-32. Alternatively, the installer may attach the fasteners 700-706 in a left-to-right manner by turning the fasteners 700-706 180 degrees from the orientation shown in FIG. 32 so that there is one of the narrow surfaces of the fastener to be installed on cable end portion 716 facing adjacent cable end portion 714.

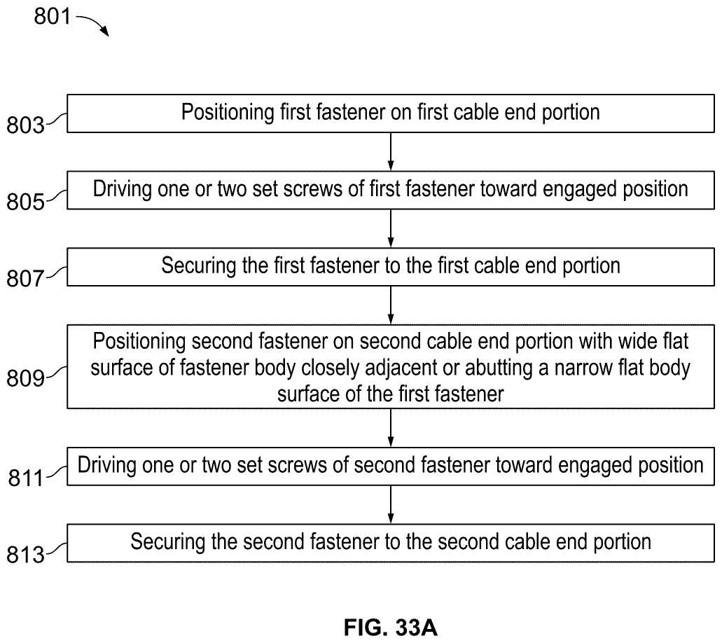

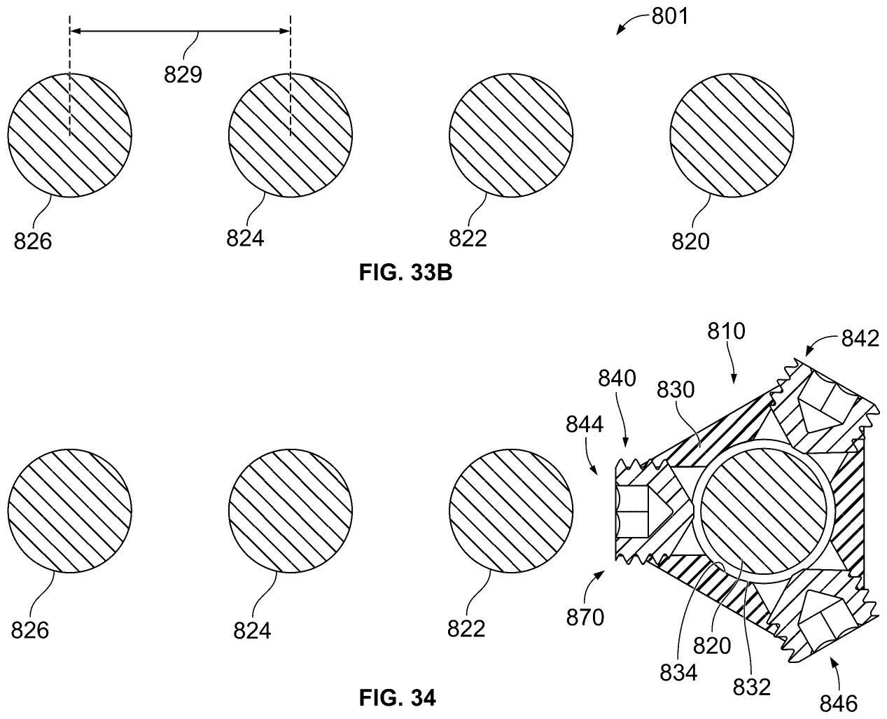

Turning to FIGS. 33A-38, a method 801 is provided for securing fasteners 810, 812, 814, 816 to cable end portions 820, 822, 824, 826 that have a pitch 829 such as 14 mm that is slightly smaller than the pitch 722 of FIG. 28B. The fasteners 810-816 including set screws 840 can be similar or the same to the fasteners 700-706 including set screws 733 discussed above in terms of their size and configuration. The method 801 is similar to the method 701 discussed above and includes steps 803, 805, 811 that are similar to the steps 703, 705, 711 discussed above.

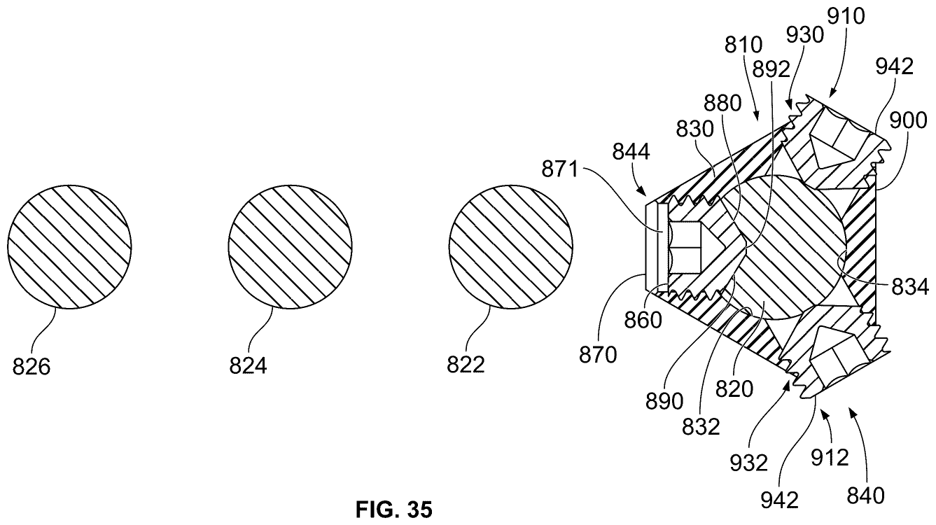

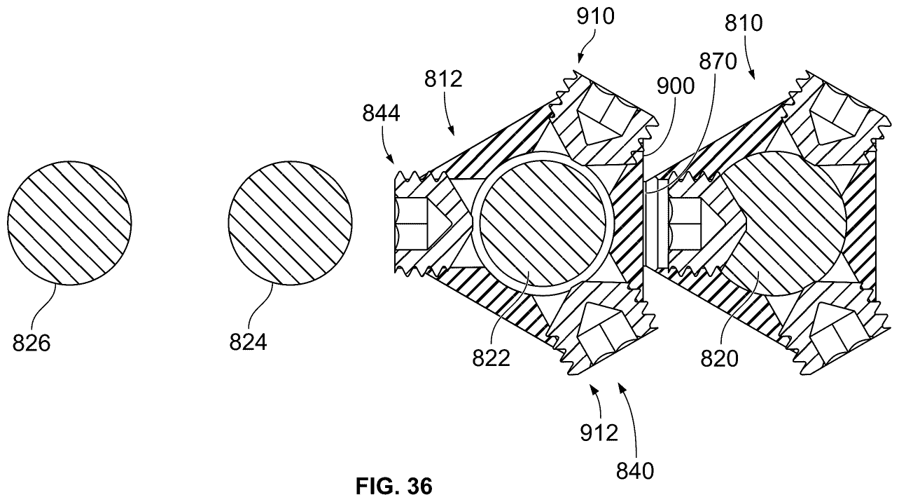

One difference between the methods 801, 701 is that the set screws 840 of row 844 of the fasteners 810-816 are driven farther radially inward than set screws 733 of row 762 (see FIG. 29) of fasteners 700-706 to more fully compress the cable end portions 820-826 in the fasteners 810-816 before the set screws of rows 842, 846 are driven to their final advanced or installed positions. Because the set screws 840 of row 844 are driven farther radially inward, the fasteners 810-816 can be positioned on the cable end portions 820-826 with no spacing between the fasteners 810-816. Specifically, the fasteners 810-816 can be positioned with a narrow flat surface 870 (see FIG. 35) of each fastener 810-816 abutting or closely adjacent to a wide flat surface 900 (see FIG. 36) of the nearby fastener 810-816. The method 801 thereby facilitates an even tighter or more compact arrangement of the fasteners 810-816 on the cable end portions 820-826 than the method 701.

The method 801 includes an installer positioning 803 the fastener 810 on the cable end portion 820 as shown in FIG. 34. The step of positioning 803 includes setting the longitudinal position of the fastener 810 along the cable end portion 820 using a stop, such as an angle iron extending across the cable end portions 820-826, and setting the rotary orientation of the fastener 810 by orienting the narrow flat surface 870 of the fastener 810 to extend vertically.

The installer then drives 805 one or two of the set screws 840 of the row 844 of the fastener 810 to an initial engaged position thereof to temporarily secure the fastener 810 to the cable end portion 820. The installer confirms or double-checks the longitudinal position and rotary orientation of the fastener 810.

The method 801 includes securing 807 the fastener 810 to the cable end portion 820. The step of securing 807 includes having the installer drive the set screws 840 of the row 844 to the final, more radially advanced positions thereof wherein a trailing end surface 860 of each of the set screws 840 is recessed or inset from the narrow flat surface 870 of the fastener 810 as shown in FIG. 35.

By shifting the set screws 840 of the row 844 radially inward to the final, advanced and recessed positions thereof, a leading end portion 880 of each of the set screws 840 of the row 844 is caused to be driven further into blind bore 832 of the fastener 810 than set screws 733 are to more fully compress the cable end portion 820 within the blind bore 832 of the fastener 810. More specifically, driving or tightening down the set screws 840 of the row 844 causes the leading end portion 880 of each of the set screws 840 to urge the cable end portion 820 against an annular inner surface 834 of the blind bore 832. The leading end portion 880 of the set screws 840 have a frustoconical surface 890 and a leading flat surface 892 that displace the cable end portion 820 in the blind bore 832. The installer tightens down the set screws 840 of the row 844 until the trailing end surface 860 of each of the set screws 840 is radially inward of the narrow flat surface 870 and the continued driving and advancing of the set screws 840 is inhibited by the compressed cable end portion 820.

Once the installer has shifted the set screws 840 of the row 844 to the final advanced positions thereof, the step of securing 807 includes having the installer shift the set screws 840 of the other rows 910, 912 radially inward to final advanced positions thereof by tightening down the remaining set screws 840. The final advanced positions of the set screws 840 of the rows 910, 912 are radially outward from those of the set screws 840 of the row 844 since the cable end portion 820 is fully compressed to its maximum extent due to the shifting of the set screws 840 of the row 844 to the radially further final advanced positions thereof. The set screws 840 have fully compressed the cable end portion 820 once the set screws 840 have compressed the cable end portion 820 against the annular inner surface 834 and have closed air gaps between wires of the cable end portion 820. Compressing the cable end portion 820 beyond the fully compressed configuration involves significantly higher torque to be applied to the set screws 840 since further compression involves deforming the wires of the cable end portion 820 and building stresses in the material of the body 830. Due to the significant increase in torque involved in attempting to compress the cable end portion 820 beyond the fully compressed configuration, the clutch of a powered driver tool being used to drive the set screws 840 may disengage the bit of the tool from the power source once the cable end portion 820 has been fully compressed by the set screws 840 of the row 844, which makes it easy for the installer to recognize that the set screws 840 of the row 844 have fully compressed the cable end portion 820,

The set screws 840 of the rows 910, 912 are generally unable to further compress the cable end portion 820 after the set screws 840 of the row 844 have fully compressed the cable end portion 820 in the blind bore 832. The installer therefore shifts the set screws 840 of rows 910, 912 to the final advanced positions thereof by tightening down the set screws 840 of the rows 910, 912 until the radially inward movement of the set screws 840 is sufficiently limited or stopped by the compressed cable end portion 820 in the blind bore 832. The set screws 840 of the rows 910, 912 have trailing end surfaces 940, 942 that project beyond radially outward of narrow flat surfaces 930, 932 of the fastener 810 as shown in FIG. 35.

Regarding FIG. 36, the method 801 next includes having the installer position 809 the fastener 812 on the cable end portion 822. Positioning the fastener 812 on the cable end portion 822 includes rotationally orienting the fastener 812 on the cable end portion 822 so that the wide flat surface 900 of the fastener 812 is closely adjacent or abutting the narrow flat surface 870 of the fastener 810. The wide flat surface 900 and narrow flat surface 870 may extend parallel to one another. The fasteners 810, 812 may contact in embodiments having cable end portions with a smaller pitch therebetween and may have a narrow spacing therebetween in embodiments having cable end portions with a larger pitch therebetween such as similar to the fasteners 700-706 for cable end portions 710-716. The fasteners 810, 812 may have a narrower spacing between the bodies 830 of the fasteners 810, 812 than the fasteners 700, 702 due to the set screws 840 of the row 844 being recessed in threaded openings 871 of the row 844. The positioning of the fastener 812 on the cable end portion 822 also includes setting the longitudinal position of the fastener 812 along the cable end portion 822 by advancing the fastener 812 proximally or in the inboard direction until it abuts against a stop such as an angle iron extending laterally across the cable end portions 820-826.

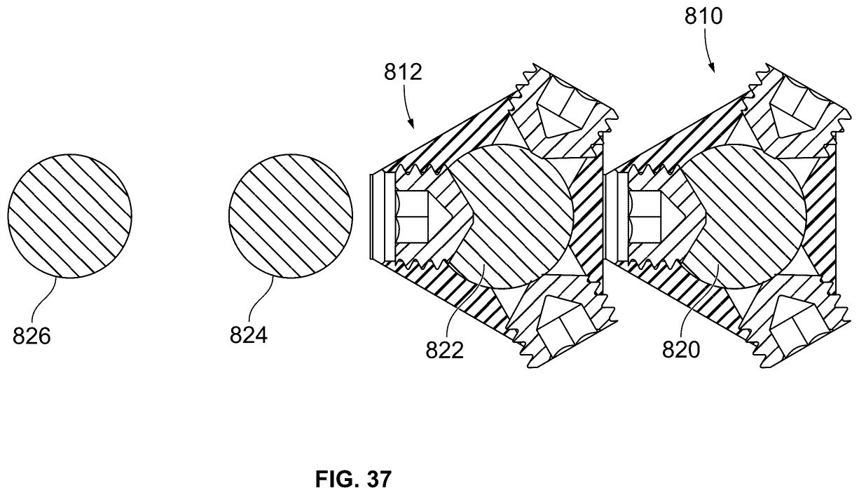

At step 811, the installer shifts one or two of the set screws 840 of the row 844 of the fastener 812 to the engaged positions thereof to temporarily secure the fastener 812 to the cable end portion 822. If the longitudinal position and rotary orientation of the fastener 812 on the cable end portion 822 are acceptable, the installer at step 813 drives the set screws 840 of the row 844 to the final more radially advanced positions thereof and drives the set screws 840 of the rows 910, 912 to final, more radially advanced positions thereof as shown in FIG. 37.

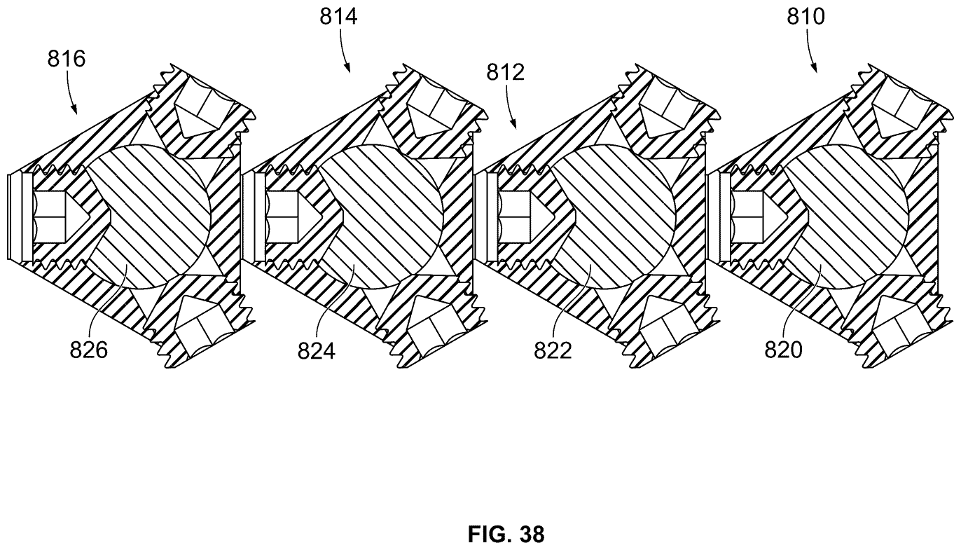

The installer sequentially applies the fasteners 814 and 816 to the cable end portions 824, 826 in a right-to-left manner using a similar approach as discussed above with respect to fasteners 810, 812. Regarding FIG. 38, the fasteners 810-816 are shown secured to the cable end portions 820-824 with the fasteners 810-816 closely adjacent one another in a side-by-side arrangement.

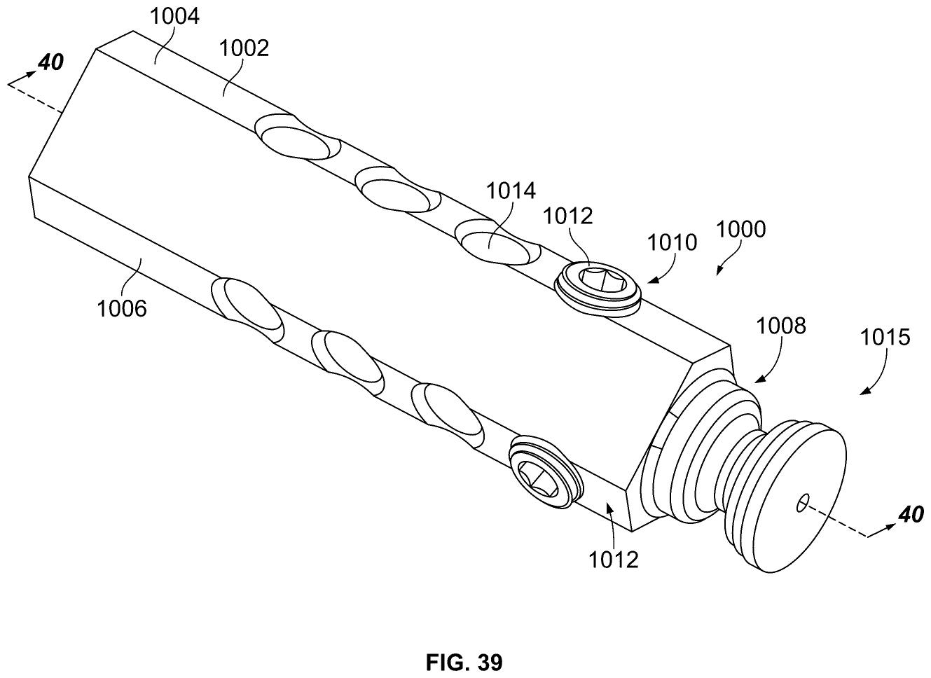

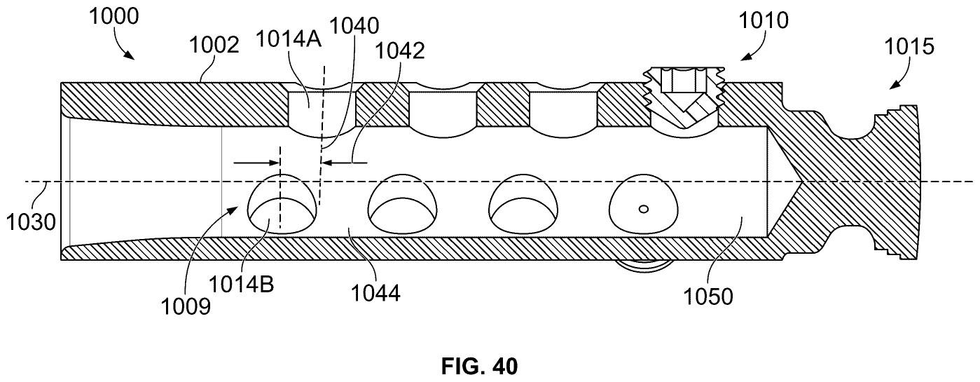

Referencing FIGS. 39 and 40, a fastener 1000 is shown that is similar to the fasteners 32, 34 discussed above such that differences will be highlighted. The fastener 1000 includes a tubular body 1002 having narrow flat surfaces 1004, 1006, 1008 with rows 1010, 1011, 1009 (see FIG. 40) of threaded set screw openings 1014 formed therein. The set screw openings 1014 receive set screws 1012.

The set screw openings 1014 of rows 1010, 1012, 1009 are longitudinally offset from one another along a central longitudinal axis 1030 of the fastener 1000. The set screw openings 1014 of the row 1010 are longitudinally closer to a distal head portion 1015 of the fastener 1000 than the corresponding set screw openings 1014 of the rows 1012, 1009. The set screw openings 1014 of the row 1009 are longitudinally farther from the head portion 1015 than the corresponding set screw openings of the rows 1010, 1012. The set screw openings 1014 of the row 1012 are longitudinally intermediate the corresponding set screw openings 1014 of the rows 1010, 1009.

For example, the set screw opening 1014A of the row 1010 has a central axis 1040 that is offset in the inboard direction by an offset distance 1042 from a central axis 1044 of a corresponding set screw opening 1014B of the row 1009 of the set screw openings 1014. Due to the offset distance 1042, set screws 1012 received in the set screw openings 1014A, 1014B will engage the cable end portion received in a blind bore 1050 of the fastener 1000 at different longitudinal positions along the cable end portion. The longitudinally offset engagement between the set screws 1012 in the set screw openings 1014A, 1014B provides an alternating compression pattern of the wires of the cable end portion and can provide additional resistance to pull-out of the cable end portion in the blind bore 1050.

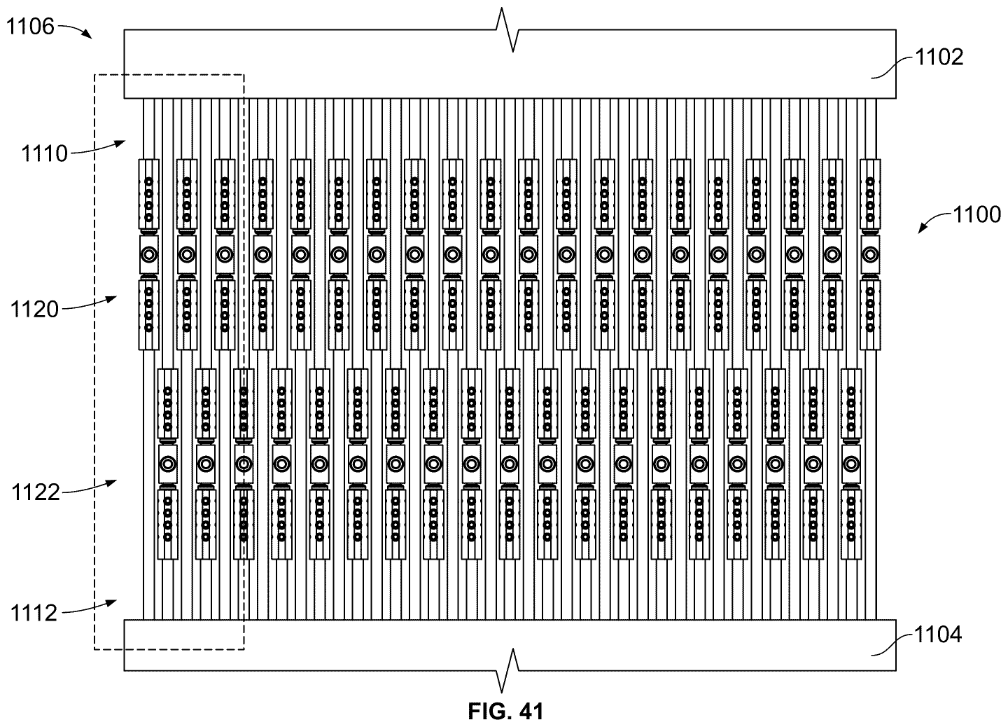

Regarding FIG. 41, a two-stage splice 1100 is provided for joining ends 1102, 1104 of a conveyor belt 1106. The conveyor belt ends 1102 include cable end portions 1110, 1112 joined together with a first group 1120 and a second group 1122 of the fastener assemblies 30 discussed above with respect to FIG. 7. The first and second groups 1120, 1122 of the fastener assemblies 30 are connected to the cable end portions 1110, 1112 so that the first and second groups 1120, 1122 of fastener assemblies 30 are longitudinally offset from one another along the conveyor belt 1106.

The longitudinal offset between the first and second groups 1120, 1122 of the fastener assemblies 30 permits the first and second groups 1120, 1122 of the fastener assemblies 30 to travel around a pulley at different rotational positions. In this manner, the pulses of tension in the cable end portions 1110, 1112 such as caused by the fastener assemblies 30 traveling onto or off of the pulley are not simultaneously applied to all of the cable end portions 1110, 1112 and their corresponding fastener assemblies 30. For example, if the fastener assemblies 30 of the first group 1120 travel onto a pulley while the fastener assemblies 30 of the second group 1122 have not yet reached the pulley, the tension in the cable end portions 1110, 1112 joined by the fastener assemblies 30 of the second group 1122 may temporarily experience a lower tension than the tension in the cable end portions 1110, 1112 joined by the fastener assemblies 30 of the first group 1120. Thus, the two stages of the splice 1100 facilitate the application of a tension pulse caused by the splice 1100 traveling onto or off of a pulley to fewer than all of the cable end portions 1110, 1112 and fastener assemblies 30 at once. Specifically, with the two-stage splice 1100, half of the cable end portions 1110, 1112 experience a tension pulse when the associated first or second group 1120, 1122 of fastener assemblies 30 travel onto or off of the pulley, while the other half of the cable end portions 1110, 1112 would temporarily experience a lower tension pulse due to the other associated groups 1120, 1122 of fastener assemblies 30 being off of, or already on, the pulley.

Regarding FIG. 43, the cable end portions 1110 include shorter cable end portions 1111 and longer cable end portions 1113. Likewise, the cable end portions 1112 include shorter cable end portions 1115 and longer cable end portions 1117. Each shorter cable end portion 1111 of the conveyor belt end 1102 is joined via one fastener assembly 30 to a corresponding one of the longer cable end portions 1117 of the conveyor belt end 1104. Each longer cable end portion 1113 of the conveyor belt end 1102 is joined via one fastener assembly 30 to a corresponding one of the shorter conveyor belt end portions 1115 of the conveyor belt end 1104. The cable end portions 1110, 1112 have longitudinal gaps 1119 therebetween that are spanned by the fastener assemblies 30.

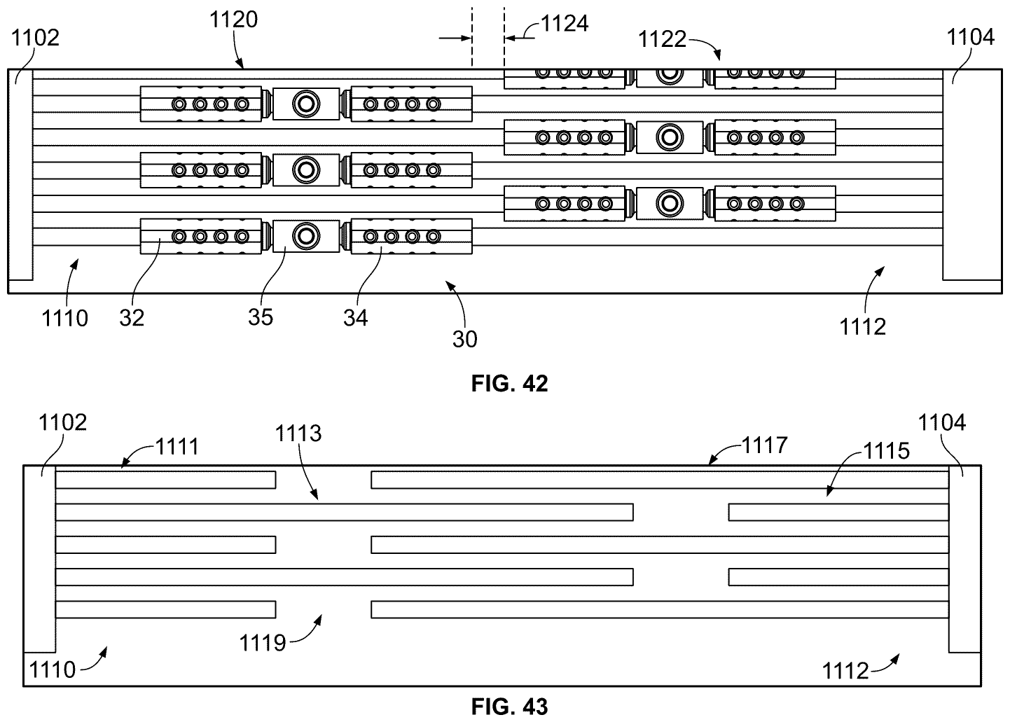

Referencing FIG. 42, each fastener assembly 30 includes upstream and downstream fasteners 32, 34 connected to the cable end portions 1110, 1112 and connectors 35 joining the upstream and downstream fasteners 32, 34. The connectors 35 are received in the longitudinal gaps 1119 between the cable end portions 1110, 1112.

In one embodiment, there is a longitudinal spacing 1124 along the conveyor belt 1106 between the first and second groups 1120, 1122 of fastener assemblies 30, as shown in FIG. 43. In another embodiment, there is no longitudinal spacing along the conveyor belt 1106 between the first and second pluralities 1120, 1122 of the fastener assemblies 30 and the fastener assemblies 30 of the first and second groups 1120, 1122 may overlap in a lateral direction.

A three-stage splice may be provided that is similar to the two-stage splice 1100. The three-stage splice utilizes three groups of the fastener assemblies 30 that are longitudinally offset along the conveyor belt 1106. The three-stage splice could further reduce the number of cable end portions 1110, 1112 and associated fastener assemblies that simultaneously experience a tension pulse as the three-stage splice travels onto or off of a roller. Specifically, a third of the cable end portions 1110, 1112 would experience the tension pulse as the associated group of fastener assemblies 30 travel onto or off of the pulley while the remaining two groups of fastener assemblies 30 are either off of the pulley or already on the pulley. The three-stage splice may be utilized, for example, for a conveyor belt having a 7000 N/mm breaking strength with 12.4 mm diameter steel cables and a pitch of 19.5 mm between the centers of the steel cables. In another embodiment, the three-stage splice may be utilized for a conveyor belt having a 5000 N/mm breaking strength with 9.2 diameter steel cables and a pitch of 15.9 mm between the centers of the steel cables.

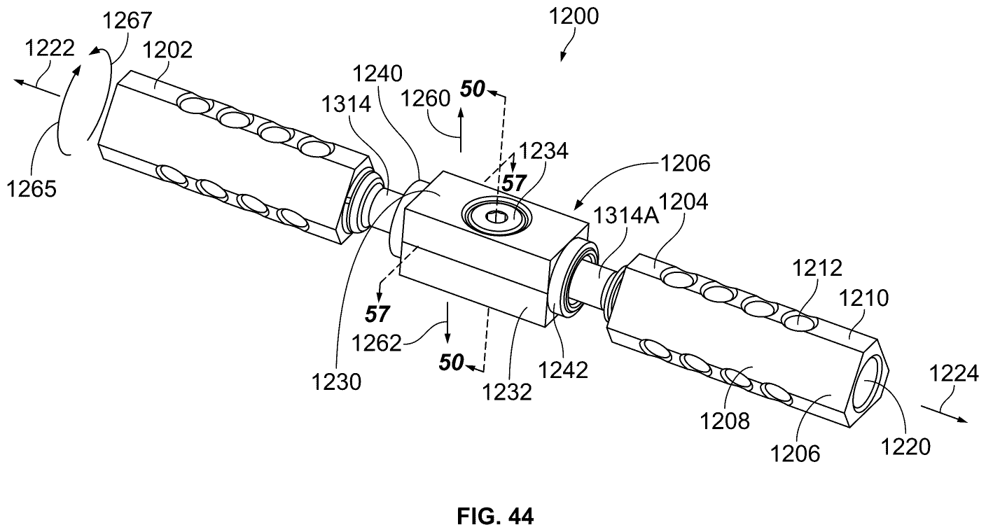

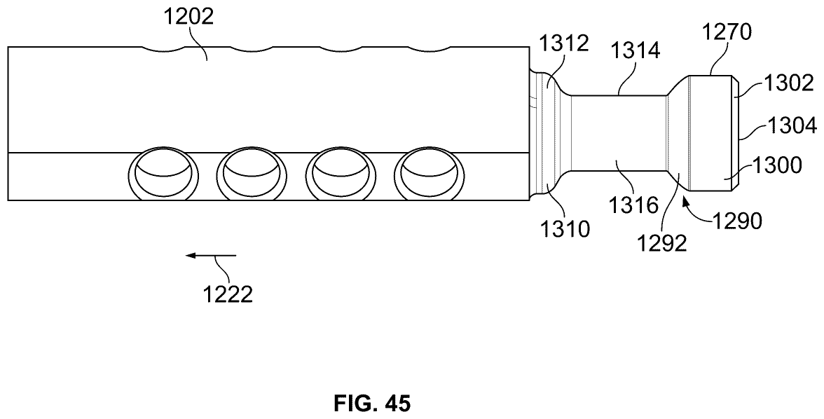

FIG. 44 illustrates a fastener assembly 1200 that is similar in many respects to the fastener assembly 30 discussed above and may be secured to cable end portions of a cable conveyor belt in a manner similar to the approaches discussed above. The fastener assembly 1200 includes an upstream cable fastener 1202, a downstream cable fastener 1204, and an intermediate connector 1206 that permits controlled shifting, e.g., pivoting and/or rotation, of the upstream and downstream fasteners relative to the connector 1206 such as when the steel cable conveyor belt 16 including a splice formed with the fastener assembly 1200 travels around a pulley. By permitting controlled relative shifting of the upstream and downstream fasteners 1202, 1204 and connector 1206, the cable end portions reorient the upstream and downstream fasteners 1202, 1204 relative to the connector 1206 as the cable end portions move and bend to position the upstream and downstream cable fasteners 1202, 1204 to efficiently transfer tensile loads between the cable end portions while limiting peak stresses in the fastener assembly 1200. Stated differently, by permitting shifting between the upstream and downstream cable fasteners 1202, 1204 and connector 1206, the fasteners 1202, 1204 can change their orientations relative to the connector 1206 (or vice versa) as the fasteners 1202, 1204 traverse a curved pulley surface and prevent an angled orientation of either cable end portion 1600, 1602 and the associated fastener 1202, 1204. Because the fasteners 1202, 1204 are kept linearly aligned with the cable end portions 1600, 1602, the cable end portions 1600, 1602 impart tensile loads on the fasteners 1202, 1204 rather than bending moments. It has been discovered that bending moments on the fasteners 1202, 1204 create stress concentrations in neck portions 1314 (see FIG. 45) of the fasteners 1202, 1204 and adversely affect the durability of the splice. The ability of the upstream and downstream fasteners 1202, 1204 to shift relative to the connector 1206 (and vice versa) provides the fastener assembly 1200 with sufficient range of motion to traverse pulleys while keeping the cable end portions 1600, 1602 applying tensile loads, rather than bending loads, to the fasteners 1202, 1204.

The upstream and downstream cable fasteners 1202, 1204 each include a body 1207 with a polygonal cross section including wider flat surfaces 1208 and narrower flat surfaces 1210. The narrower flat surfaces 1210 have rows of threaded openings 1212 to receive set screws. The body 1207 has a blind bore 1220 to receive a cable end portion.

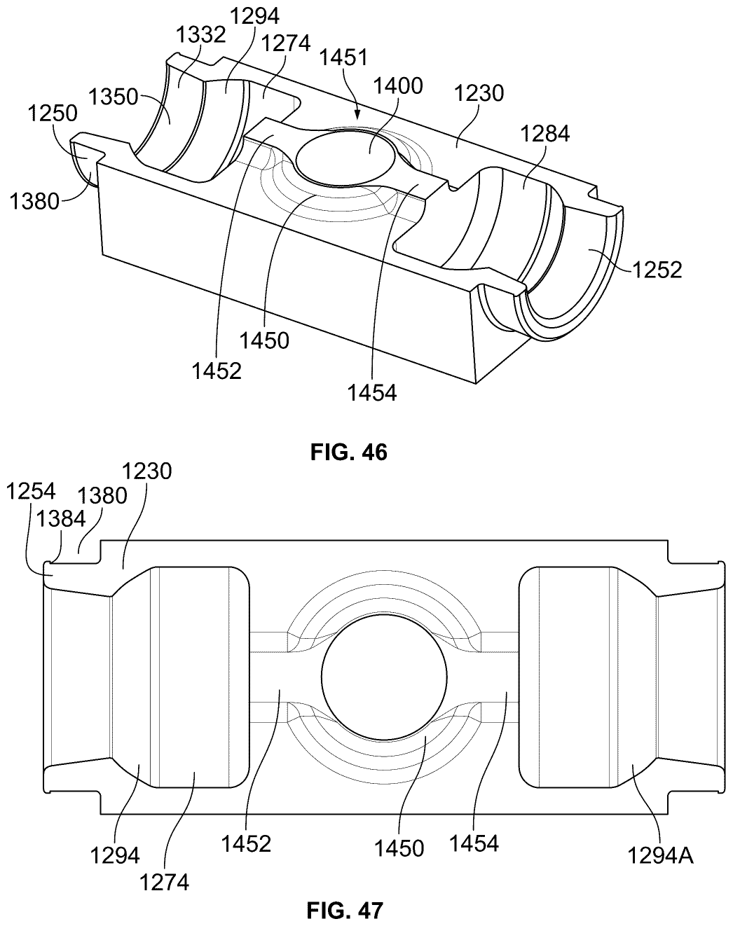

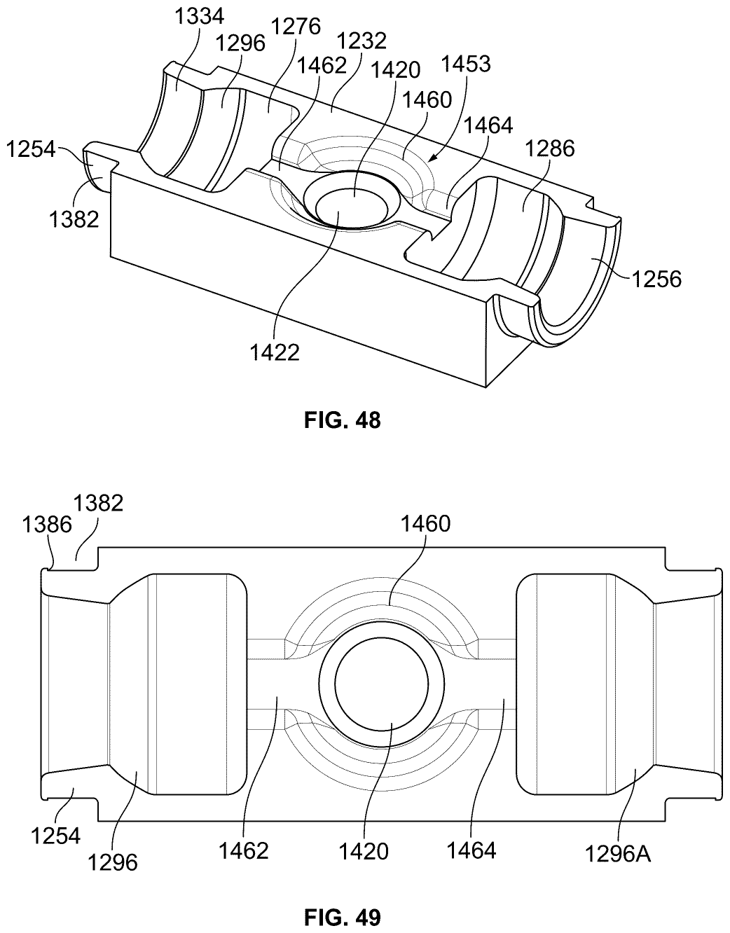

The connector 1206 has an upper connector member 1230, a lower connector member 1232, and a first attachment member such as a threaded attachment member in the form of a screw 1234 connecting the upper and lower connector members 1230, 1232. The connector 1206 further includes second and third attachment members such as rings 1240, 1242 that are press fit onto end arcuate flange portions 1250, 1252, 1254, 1256 (see, FIGS. 46 and 48) of the upper and lower connector members 1230, 1232. The rings 1240, 1242 may be made of a durable, high strength material such as steel. Example materials include 4140 pre-hardened steel and tempered 17-4 PH stainless steel.

To splice ends of a conveyor belt using the fastener assembly 1200, cable end portions of the conveyor belt ends are inserted into the blind bores 1220 of the upstream and downstream fasteners 1202, 1204 and the set screws are tightened down to secure the cable end portions in the blind bores 1220. Next, the connector 1206 is assembled with the upstream and downstream fasteners 1202, 1204 (as described further hereinafter). Fastener assemblies 1200 are similarly connected to the other cable end portions of the conveyor belt and the fastener assemblies 1200 are covered in filler, as has previously been described.

Once the splice has been installed, the conveyor belt is tensioned which causes the cable end portions secured to the upstream and downstream fasteners 1202, 1204 to apply tensile forces in directions 1222, 1224. The tensile forces acting in directions 1222, 1224 tightly engage enlarged head portions 1270, 1280 (see, FIG. 56) of the upstream and downstream fasteners 1202, 1204 with stop surfaces, such as semiannular, partially spherical surfaces 1294, 1294A (see, FIG. 47) of the upper connector member 1230 and semiannular, partially spherical surfaces 1296, 1296 (see, FIG. 49) of the lower connector member 1232. The screw 1234 and rings 1240, 1242 of the connector 1206 resist separation of the upper and lower connector members 1230, 1232 in directions 1260, 1262 transverse to the tensile force direction 1222, 1224 that may be caused by the cable end portion tensile load urging the upstream and downstream fasteners apart in directions 1222, 1224 and the engagement of curved surfaces of the head portions 1270, 1280 being pulled forcefully against the spherical surfaces 1294, 1294A.

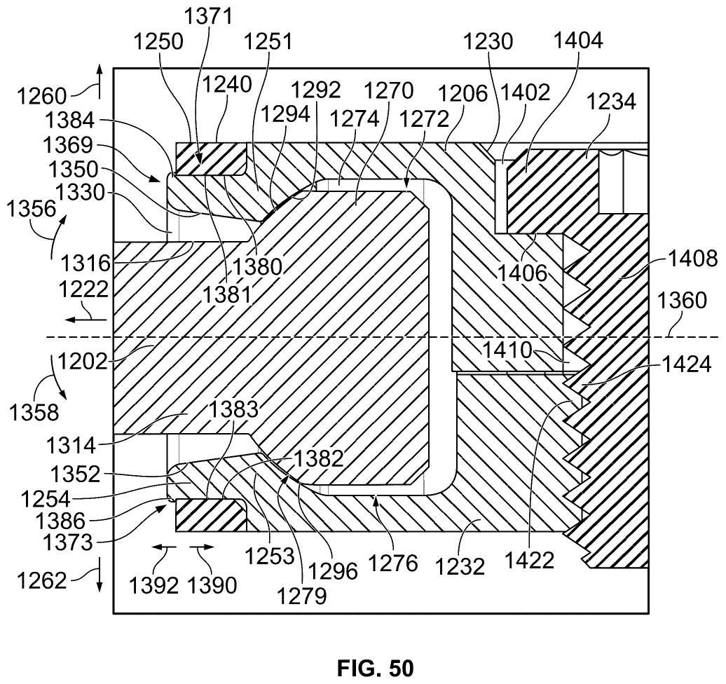

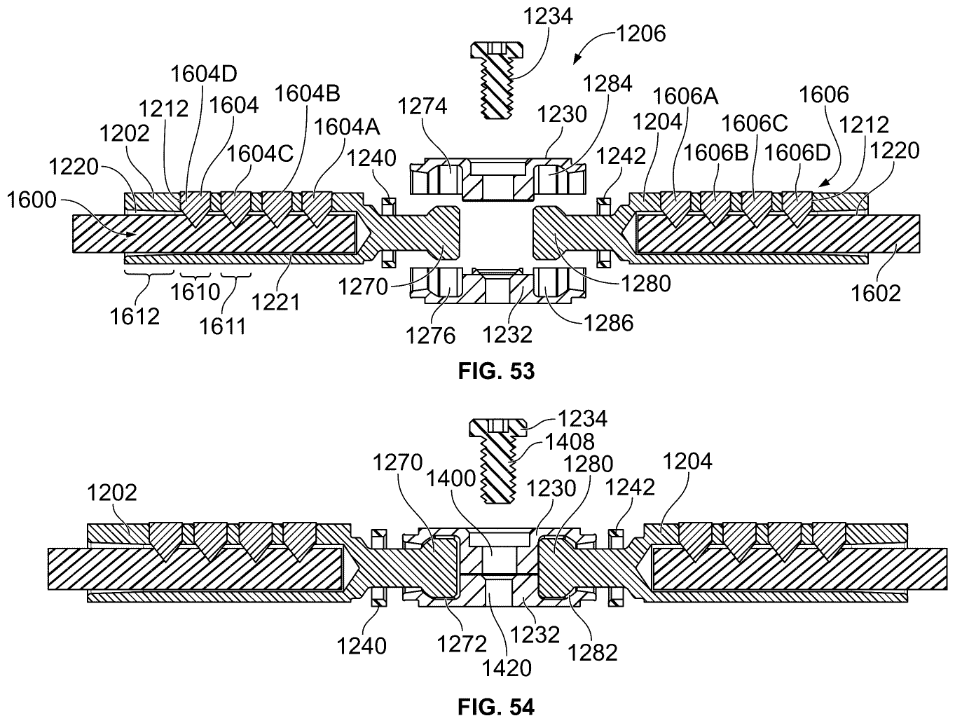

Referring next to FIG. 45, the upstream cable fastener 1202 will be described understanding that the downstream cable fastener 1204 has an identical construction. The upstream cable fastener 1202 has a head portion 1270 that is sized to be received in an upstream connector pocket 1272 (see, FIG. 50) formed by an upper, end pocket portion 1274 (see, FIG. 46) of the upper connector member 1230 and a lower, end pocket portion 1276 (see, FIG. 48) of the lower connector member 1232. Similarly, the downstream cable fastener 1204 has a head portion 1280 (see, FIG. 53) sized to be received in a downstream connector pocket 1282 (see FIG. 54) formed by an upper, end pocket portion 1284 (see, FIG. 46) of the upper connector member 1230 and a lower, end pocket portion 1286 (see, FIG. 48) of the lower connector member 1232.

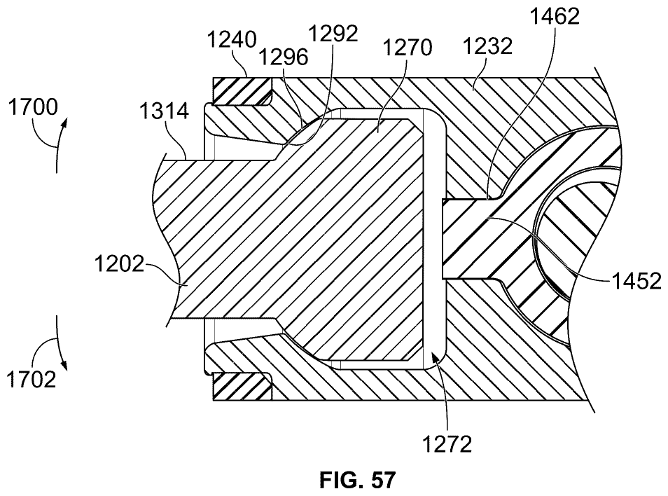

Continuing reference to FIG. 45, the head portion 1270 has a stop surface 1290 to inhibit pull out of the head portion 1270 in direction 1222 due to the tension in the associated cable end portion. In one embodiment, the stop surface 1290 includes a partially spherical surface 1292 that rotatably and pivotally engages with the semiannular partially spherical shoulder surfaces 1294 (see, FIGS. 46) and 1296 (see, FIG. 48) of the upper and lower connector members 1230, 1232. The engaged partially spherical surface 1292 of the head portion 1270 and the semiannular partially spherical surfaces 1294, 1296 of the upper and lower connector members 1230, 1232 permit rotatable and pivotal movement of the head portion 1270 in the connector pocket 1272 including up/down in directions 1356, 1358 (see FIG. 50) and laterally left/right in directions 1700, 1702 (see FIG. 57), and movements in compound directions such as in laterally left and up and laterally right and down directions. The engaged, partially spherical surfaces 1292, 1294, 1296 operate as a ball-and-socket connection that, as mentioned, also allows rotatable movement of the upstream cable fastener 1202 in rotary directions 1265, 1267 (see, FIG. 44). In this manner, the upstream cable fastener 1202 generally has a conical range of movement relative to the connector 1206 as the cable end portion secured to the upstream cable fastener 1202 moves and bends during operation of the associated conveyor belt. The downstream cable fastener 1204 has a similar conical range of movement relative to the connector 1206.

With reference to FIG. 45, the head portion 1270 includes a cylindrical surface portion 1300, a tapered bevel surface portion 1302, and a transverse flat end surface portion 1304. The cylindrical surface portion 1300 extends from the spherical surface portion 1292 to the tapered bevel surface portion 1302 which extends to the transverse flat end surface portion 1304. The fastener 1202 has a base portion 1310 with an annular shoulder surface 1312 that tapers down to a narrowed neck portion 1314 of the upstream cable fastener 1202. The neck portion 1314 has an annular neck surface portion 1316 extending between the shoulder surface 1312 and the partially spherical surface 1292 of the enlarged head portion 1270.

As shown in FIGS. 46-49, the upper and lower connector members 1230, 1232 have mating alignment portions 1451, 1453 that are configured to matingly engage each other to ensure proper alignment of the upper and lower connector members 1230, 1232. The alignment portion 1451 of the upper connector member 1230 includes raised arcuate protrusions 1450 extending about the upper opening 1400 and diametrically opposite, raised ridges 1452, 1454 extending radially from the opening 1400 and between ends of the protrusions 1450, as can be seen in FIGS. 46 and 47. The alignment portion 1453 of the lower connector member 1232 includes a recess 1460 extending about the lower threaded opening 1420 and diametrically opposite channels 1462, 1464 extending radially from the opening 1420 to interrupt the recess 1460 as they extend therethrough, as can be seen in FIGS. 48 and 49. When the upper and lower connector members 1230, 1232 are brought together about the fastener head portions 1270, 1280 (see, FIGS. 53 and 54), the protrusions 1450 engage in the recess 1460 and the ridges 1452, 1454 engage in the channels 1462, 1464.

Referring to FIG. 50, the connector 1206 has an entry opening 1330 that is formed by an upper concave recessed opening 1332 (see FIG. 46) of the upper connector member 1230 and a lower concave recessed opening 1334 (see FIG. 48) formed by the lower connector member 1232 when the connector members 1230, 1232 are secured together. When the fastener assembly 1200 is assembled with the upstream cable fastener 1202 adjustably connected to the connector 1206, the neck portion 1314 of the upstream cable fastener 1202 extends into the end entry opening 1330 to position the enlarged head portion 1270 of the upstream cable fastener 1202 in the connector end pocket 1272. The upper and lower connector members 1230, 1232 have neckdown portions 1251, 1253 that have a smaller diameter than the varying diameter across the end pocket 1272 to narrow the entry opening 1330 and inhibit pull-out of the upstream fastener head portion 1270 from the end pocket 1272.

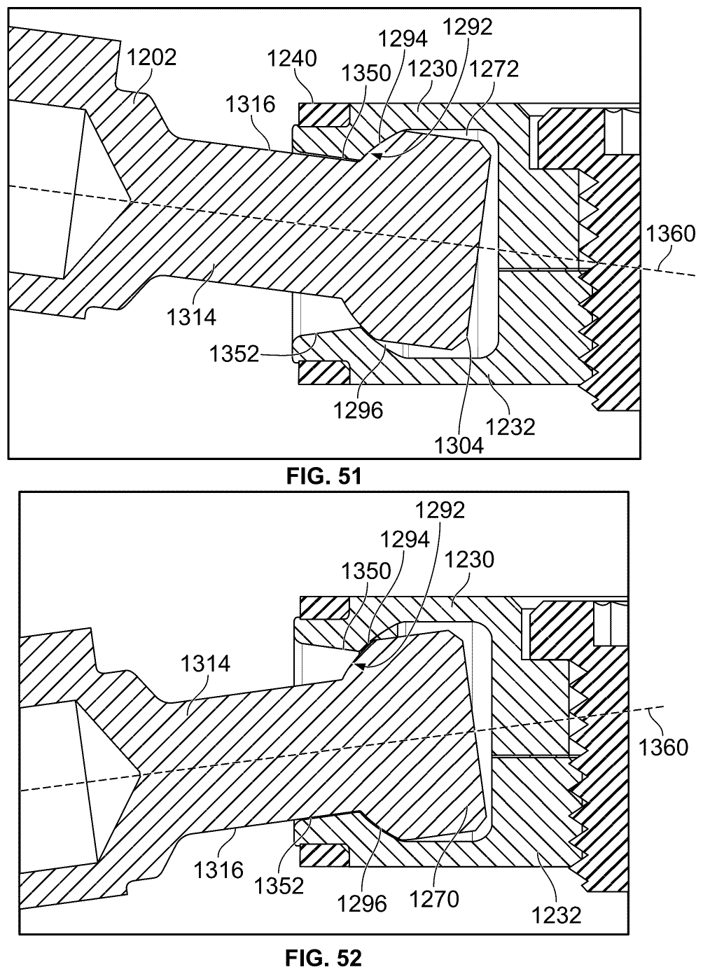

When the conveyor belt is tensioned, the upstream cable fastener 1202 is urged in the direction 1222 which tightly engages the partially spherical surface 1292 of the head portion 1270 with the semiannular partially spherical surfaces 1294, 1296 of the upper and lower connector members 1230, 1232. The end arcuate flange portion 1250 of the upper connector member 1230 has an upper tapered collar inner surface 1350 and the end arcuate flange portion 1254 of the lower connector member 1232 has a lower tapered collar inner surface 1352. As shown in FIGS. 50 and 51, the upper tapered collar inner surface 1350 is configured to engage the annular neck surface portion 1316 of the upstream cable fastener 1202 and limit pivoting of the fastener 1202 in direction 1356. The upper tapered collar inner surface 1350 has a semifrustoconical surface that flares outward or expands radially as the upper tapered collar inner surface 1350 extends in an outboard direction, e.g., direction 1222.

Conversely, as shown in FIGS. 50 and 52, the lower tapered collar inner surface 1352 is configured to engage the annular neck surface portion 1316 of the upstream cable fastener 1202 and limit pivoting of the upstream cable fastener 1202 in direction 1358. The lower tapered collar inner surface 1352 also has a semifrustonical surface that flared outwardly or expands radially as the lower tapered collar inner surface 1352 extends in an outboard direction, e.g., direction 1222.

Further, the upper and lower tapered collar inner surfaces 1350, 1352 also cooperate to engage the annular neck surface portion 1316 of the upstream cable fastener 1202 and limit pivoting of the upstream cable fastener 1202 in lateral or side-to-side directions 1700, 1702 (see, FIG. 57). In this manner, the upper and lower tapered collar inner surfaces 1350, 1352 define the conical range of movement of the fastener, and, in the illustrated form, limit the fastener 1202 to a range of pivoting of +/−8° from a central position as shown in FIG. 50. In other words, the fastener 1202 is able to pivot so that a central axis 1360 of the fastener 1202 at 0° in FIG. 50 and be pivoted upwardly 8° in FIG. 51 and pivoted downwardly 8° in FIG. 52. Further, the ball-and-socket connection of the upstream fastener head portion 1270 and upstream connector pocket 1272 enables rotary of the upstream cable fastener 1202 about the central axis 1360. By providing the limited conical range of movement, stresses in the fastener 1202 during conveyor belt operation are kept within an acceptable range while allowing for shifting of the fastener 1202 relative to the connector 1206 and also avoiding failures of the fastener assembly 1200 such as when traveling over belt pulleys.

Returning to FIG. 50, the end arcuate flange portions 1250, 1254 have a semiannular configuration and include semiannular exterior channel portions 1380, 1382 and semiannular ring-retaining lip portions 1384, 1386 to form an end annular flange 1369, annular exterior channel 1371 of the end flange 1369, and annular lip 1373 of the channel 1371 when the upper and lower connector members 1230, 1232 are secured together by the screw fastener 1234. The ring 1240 is press-fit in direction 1390 onto the end flange 1369 to be received in the annular channel 1371 thereof. The press-fitting of the ring 1240 involves resiliently, radially deforming and expanding the ring 1240 to temporarily increase the inner diameter of the ring 1240 to fit over the semicircular ring-retaining lip 1373. The ring 1240 snaps into the semicircular channel 1371 once the ring 1240 advances past the semicircular ring-retaining lip 1373 and returns to a less radially expanded configuration in the channel 1371. In another embodiment, the press-fitting of the ring 1240 onto the end annular flange 1369 involves resiliently deforming the end annular flange 1369 in addition to, or instead of, deforming the ring 1240.

With the ring 1240 received in the exterior channel 1371, the ring 1240 is firmly and tightly resiliently engaged with annular outer surface 1381, 1383 of the channel 1371. Further, the annular ring-retaining lip 1373 inhibits shifting of the ring 1240 off of the annular end flange 1369 in direction 1392 away from the connector 1206 and toward the fastener 1202. In this manner, the ring 1240 encircles and inhibits separation of the end arcuate flange portions 1250, 1254. The ring 1240 thereby resists a camming force the upstream fastener head portion 1270 applies against the annular partially spherical surface 1279 formed by the semiannular partially spherical surfaces 1294, 1296, which urges the upper and lower connectors members 1230, 1232 apart in directions 1260, 1262, when the upstream fastener is subjected to a tensile load in direction 1222 by the associated cable end portion. Accordingly, the ring 1240 ensures that the separation forces are not exclusively taken by the screw fastener 1234. The ring 1242 likewise encircles and inhibits separation of the end arcuate flange portions 1252, 1256 at the other end of the connector 1206.

Referring to FIGS. 46 and 50, the upper connector member 1230 has an upper opening 1400 with a countersunk upper portion 1402 sized to receive a head portion 1404 of the screw 1234. The head portion 1404 seats against a stop surface 1406 of the countersunk upper portion 1402 and a shank portion 1408 of the screw 1234 extends to a lower bore portion 1410 of the upper opening 1400. Referring to FIGS. 48 and 50, the lower connector member 1230 has a lower threaded opening 1420 aligned with lower bore portion 1410 and having threads 1422 that are configured to engage with threads 1424 of the shank portion 1408 of the screw 1234.

With reference to FIGS. 53-56, a method is provided for connecting cable end portions 1600, 1602 using the fastener assembly 1200. Regarding FIG. 53, the method includes initially securing the upstream and downstream fasteners 1202, 1204 to the cable end portions 1600, 1602 by positioning the cable end portions 1600, 1602 in the blind bores 1220 of the upstream and downstream fasteners 1202, 1204. Next, set screws 1604, 1606 are advanced into the threaded openings 1212 and are tightened down to secure the cable end portions 1600, 1602 in the blind bores 1202.

In one approach, set screws 1604A, 1604B, 1604C are tightened down with a first torque and set screw 1604D is tightened with a reduced torque. It has been found that a reduced torque for one or more inboard set screws 1604, e.g., set screw 1604D, provides a transition portion 1610 in the wires of the cable end portion 1600 aligned with or in the area of the set screw 1604D. The transition portion 1610 provides a portion of the wires with reduced stress as applied by the set screw 1604D adjacent a higher stress portion 1611 of the wires as applied by the adjacent outboard set screw 1604C and a more inboard lower stress portion 1612 of the wires where there are no set screws applying force to the cable wires. The wires of the cable end portion 1600 have higher stress in the higher stress portion 1611 because the wires are deformed by the set screw 1604C and compressed with a greater force against an inner surface 1221 of the blind bore 1220 than the wires of the cable end portion 1600 in the area of the set screw 1604D. The wires of the cable end portion 1600 have a lower stress in the lower stress portion 1612 because the wires are not clamped by set screws in the lower stress portion 1612 and can shift relative to one another.

The transition portion 1610 provides a gradual transition in the stress of the wires of the cable end portion 1600 between the higher stress portion 1611 and the lower stress portion 1612. It has been found that the reduced torque applied to the set screw 1604D, and the associated gradual transition in the stress of the wires of the cable provided by the transition portion 1610, increases the durability of the connection between the upstream cable fastener 1202 and cable end portion 1600. The durability of the connection between the upstream cable fastener 1202 and the cable end portion 1600 is improved because the gradual transition in the stress of cable the wires of the cable end portion 1600 provided by the transition portion 1610 reduces stress risers that may occur in the wires of the cable end portion 1600 when the wires shift relative to one another during operation of the conveyor belt. As an example, set screws 1604A, 1604B, 1606C are tightened with a torque of 30 ft-lbs and the set screw 1604D is tightened with a torque of 15 ft-lbs. The set screws 1606 of the downstream cable fastener 1204 are tightened down in a manner similar to the set screws 1604 of the upstream fastener 1204, with an inboard set screw 1606D being tightened down with a reduced torque compared to set screws 1606A, 1696B, 1606C, 1606C.

In another approach, the set screws 1604, 1606 have two or more inboard set screws 1604, 1606 with a reduced torque. For example, set screws 1604A, 1604B may be tightened with 100% of a maximum torque, set screw 1604C is tightened with 75% of the maximum torque, and set screw 1604D is tightened with 50% of the maximum torque. Although one row of set screws 1604A-1604D is discussed, the other rows of set screws of the upstream cable fastener 1202 may be tightened in a manner similar to the row of set screws 1604 discussed in FIG. 53.

Once the upstream and downstream fasteners 1202, 1204 have been secured to the cable end portions 1600, 1602, the intermediate connector 1206 is assembled. The upper and lower connector members 1230, 1232 of the intermediate connector 1206 are positioned to align the upper pocket portions 1274, 1284 of the upper connector member 1230 and the lower pocket portions 1286 of the lower connector member 1232 with the head portions 1270, 1280 of the upstream and downstream fasteners 1202, 1204. As shown in FIG. 54, the upper and lower connector members 1230, 1232 are brought together to form the connector pockets 1272, 1282 about the head portion 1270, 1280 of the upstream and downstream cable fasteners 1202, 1204.

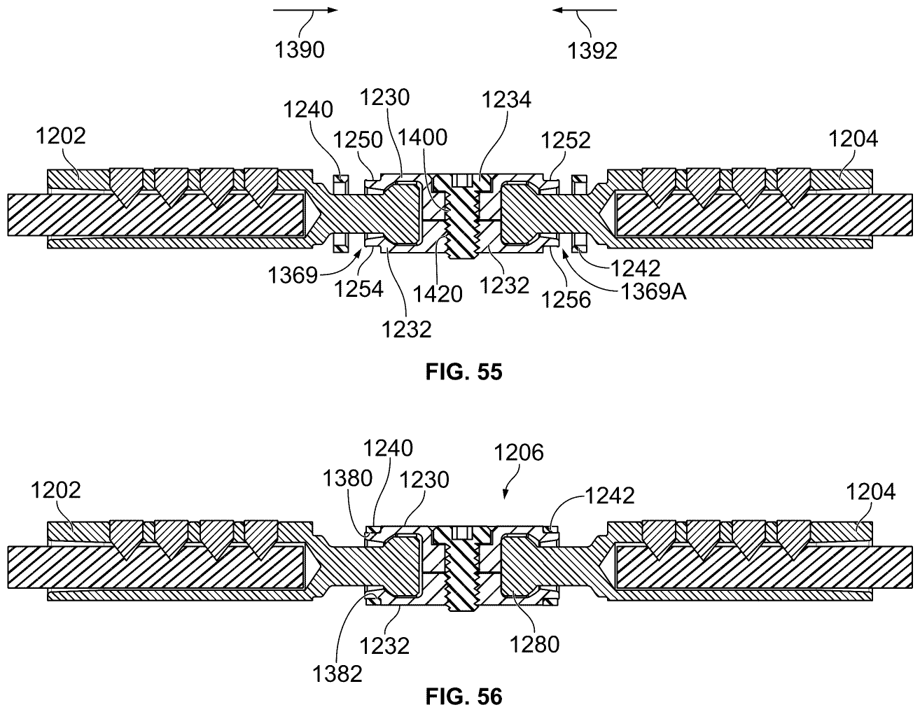

Next, the installer advances the shank portion 1408 of the screw 1234 into the upper opening 1400 of the upper connector member 1230, threadingly engages the shank portion 1408 with the lower threaded opening 1420 of the lower connector member 1232, and tightens down the screw 1234 to seat the head portion 1404 of the screw 1234 in the countersunk opening 1402 of the upper connector member 1230 and secure the upper and lower connector members 1230, 1232 together, as shown in FIG. 55.

As shown in FIGS. 55 and 56, the rings 1240, 1242 are advanced in directions 1390, 1392 toward the intermediate connector 1206 and onto the end annular flanges 1369, 1369A formed by the end arcuate flange portions 1250, 1254 and 1252, 1256 of the upper and lower connector members 1230, 1232. In another approach, the rings 1240, 1242 are pressed onto the end arcuate flange portions 1250, 1254 and 1252, 1256 before attaching the screw 1234 to the upper and lower connector members 1230, 1232.

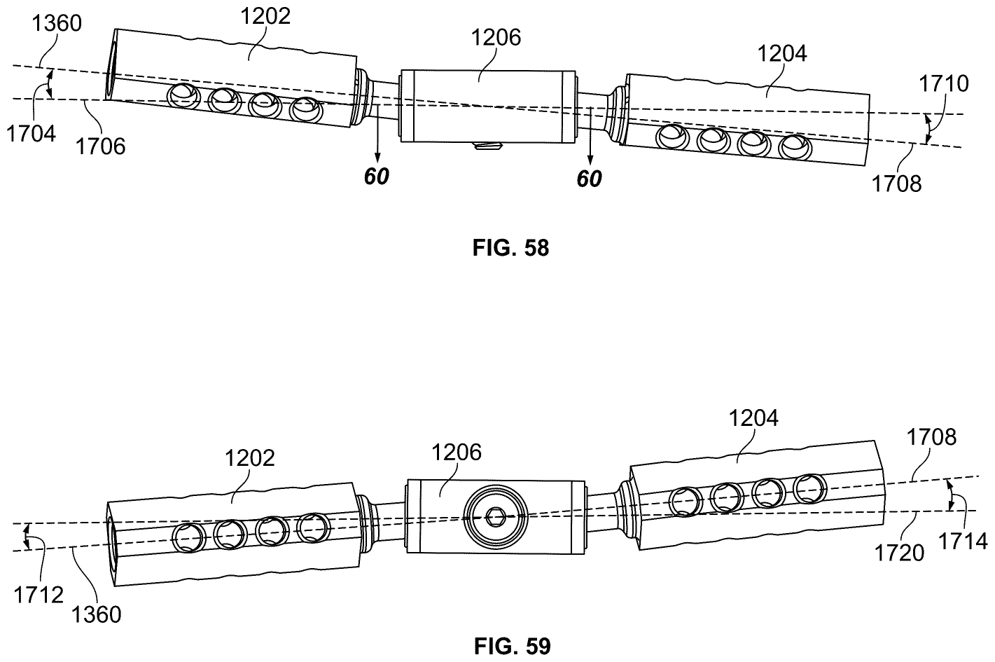

The connector pockets 1272, 1282 of the connector 1206 and the head portions 1270, 1280 of the upstream and downstream fasteners 1202, 1204 are configured to accommodate non-linear tension application in the associated conveyor belt. For example, as shown in FIGS. 58 and 59, the upstream and downstream fasteners 1202, 1204 are vertically askew of offset relative to the connector 1206. More specifically, the upstream cable fastener 1202 is pivoted upwardly so that a central axis 1360 of the upstream fastener 1402 is at a positive angle 1704 relative to a horizontal central axis 1706 of the connector 1206. Conversely, the downstream fastener 1404 is pivoted downwardly so that a central axis 1708 of the downstream fastener 1404 is at a negative angle 1710 relative to the horizontal central axis 1706. The positive angle 1704 may be +8° and the negative angle 1710 may be −8°. The relative pivoting movement of the upstream and downstream fasteners 1202, 1204 and connector 1206 may include pivoting of the connector 1206 as well.

Referring to FIG. 59, the upstream and downstream fasteners 1202, 1204 are also laterally askew or offset and are pivoted in lateral directions so that the central axes 1360 and 1708 are at angles 1712, 1714 relative to a central longitudinal axis 1720 of the connector 1206. If the connector 1206 is induced to rotate (e.g., turn clockwise or counterclockwise when viewed in FIGS. 58 and 59) from an original installation orientation during operation of the conveyor belt, the fasteners 1202, 1204 are still able to shift relative to the connector 1206. For example, the fastener 1202 can still pivot in directions 1356, 1358, rotate in directions 1265, 1267, or a combination thereof. Likewise, if one or both of the fasteners 1202, 1204, is induced to rotate from an original installation orientation during operation of the conveyor belt, the fasteners 1202, 1204 and connector 1206 can still shift relative to one another.

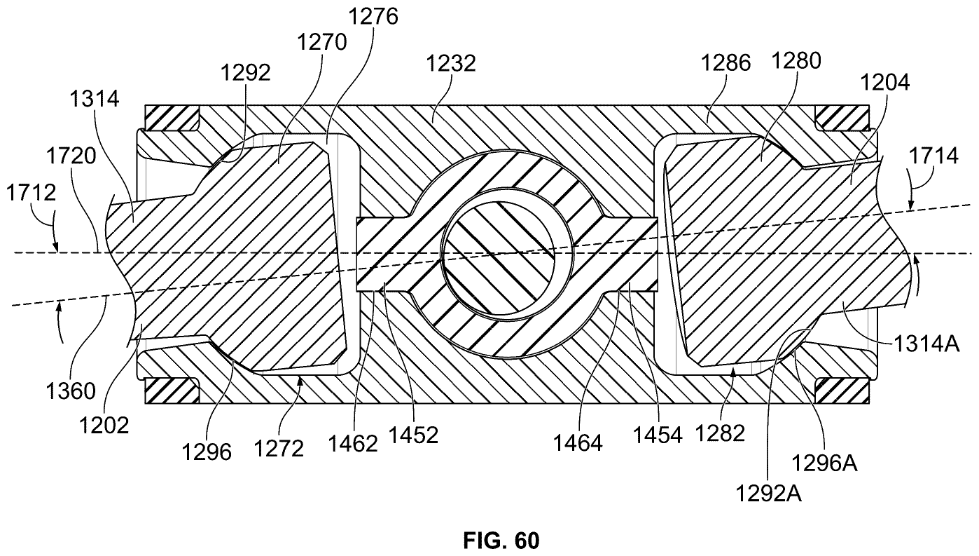

Regarding FIG. 60, the upstream and downstream connector pockets 1272, 1282 of the connector 1206 each include an annular partially spherical surface 1279 (see FIG. 50) formed by the partially spherical surfaces 1294, 1296 (for upstream connector pocket 1272) or the partially spherical surfaces 1294A, 1296A (for the downstream connector pocket 1282). The annular partially spherical surfaces 1279 of the connector 1206 permit the partially spherical surfaces 1292, 1292A of the fastener head portions 1270, 1280 to pivot to the angles 1712, 1714 relative to the central axis 1720 of the connector 1406.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A fastener assembly for joining first and second cable end portions of a cable conveyor belt, the fastener assembly comprising:
a first cable fastener having a first head portion and a first plurality of locking members to secure the first cable fastener to the first cable end portion;
a second cable fastener having a second head portion and a second plurality of locking members to secure the second cable fastener to the second cable end portion; and
a connector having a first pocket sized to receive the first head portion and a second pocket sized to receive the second head portion, the first and second pockets and the first and second head portions configured to permit shifting of the first and second cable fasteners relative to the connector during operation of the cable conveyor belt.

2. The fastener assembly of claim 1 wherein the connector comprises an upper connector member and a lower connector member, the upper and lower connector members having pocket portions that cooperate to form the first and second pockets; and
an attachment member to secure the upper and lower connector members about the first and second head portions.

3. The fastener assembly of claim 2 wherein the attachment member comprises a threaded attachment member.

4. The fastener assembly of claim 2 wherein the attachment member comprises a threaded attachment member and retainer rings.

5. The fastener assembly of claim 1 wherein the connector comprises:
an upper connector member and a lower connector member to be assembled about the first and second head portions of the first and second cable fasteners, each of the upper and lower connector members having a pair of end arcuate flange portions that cooperate to form end annular flanges at opposite ends of the connector; and
retainer rings configured to extend about the end annular flanges of the connector and resist separation of the upper and lower connector members.

6. The fastener assembly of claim 5 wherein the upper and lower connector members include openings to be aligned with the upper and lower connector members assembled about the first and second head portions of the first and second cable fasteners; and
a threaded attachment member to extend through the aligned openings and resist separation of the upper and lower connector members.

7. The fastener assembly of claim 1 wherein the connector pockets and the fastener head portions include partially spherical surface portions configured to engage each other for allowing shifting of the first and second cable fasteners relative to the connector.

8. The fastener assembly of claim 7 wherein the first and second cable fasteners include first and second neck portions;
wherein the connector includes openings leading to the first and second pockets to receive the first and second neck portions of the first and second cable fasteners; and
wherein the connector includes neckdown portions extending about the openings configured to contact the first and second neck portions and limit shifting of the first and second cable fasteners relative to the connector.

9. The fastener assembly of claim 1 wherein the first and second cable fasteners include first and second neck portions having annular neck surfaces;
wherein the connector includes openings leading to the first and second pockets to receive the first and second neck portions of the first and second cable fasteners; and
wherein the connector includes annular stop surfaces extending about the openings configured to contact the neck surfaces and limit shifting of the first and second cable fasteners relative to the connector.

10. The fastener assembly of claim 1 wherein the first and second cable fasteners include bores for receiving the first and second cable end portions; and
wherein the first and second pluralities of locking members comprise set screws to engage the first and second cable end portions received in the bores of the first and second cable fasteners.

11. A cable fastener for connecting cable end portions of a conveyor belt, the fastener comprising:
a body having a bore to receive a cable end portion;
an inner surface of the body extending around the bore;
a plurality of narrow outer surfaces of the body;
a plurality of wide outer surfaces of the body alternating with the narrow outer surfaces about the body;
rows of threaded openings of the narrow outer surfaces, the threaded openings extending to the inner surface;
set screws in the threaded through openings and operable to secure the cable end portion in the bore;
thicker portions of the body extending between the inner surface and the narrow outer surfaces to strengthen the body adjacent the rows of threaded through openings; and
thinner portions of the body extending between the inner surface and the wide outer surfaces to allow the cable fastener to be compactly positioned adjacent to a cable fastener secured to an adjacent cable end portion of the conveyor belt.

12. The cable fastener of claim 11 wherein the set screws each include a leading end portion to contact the cable end portion in the bore and a trailing end portion opposite the leading end portion; and
wherein the threaded openings are sized to permit the set screws to be advanced to a locked position in the threaded openings wherein the set screw trailing end portions are flush with or spaced inwardly from the narrow outer surfaces of the body.

13. The cable fastener of claim 11 wherein the narrow outer surfaces are flat and the wide outer surfaces are flat; and
wherein the body includes corner junctures connecting the narrow outer surfaces and the wide outer surfaces.

14. The cable fastener of claim 11 wherein the fastener has a length and the narrow and wide outer surfaces extend a majority of the length of the fastener.

15. The cable fastener of claim 11 wherein the body includes a head portion configured to be received in a connector of a fastener assembly.

16. The cable fastener of claim 15 wherein the body has a narrowed neck portion intermediate the head portion and the narrower and wider outer surfaces along the body.

17. The cable fastener of claim 11 wherein the body includes a head portion configured to be received in a connector of a fastener assembly; and
wherein the head portion includes a partially spherical head surface to engage a partially spherical surface of the connector and permit shifting of the fastener relative to the connector.

18. The cable fastener of claim 11 wherein the rows of threaded openings include three rows of threaded openings separated by approximately 120 degrees about the bore.

19. The cable fastener of claim 11 wherein the body has a unitary, one-piece construction.

20. A method of connecting cable end portions of a cable conveyor belt, the method comprising:
securing cable fasteners to the cable end portions;
aligning head portions of the cable fasteners with pocket portions of connector members of a connector;
shifting the connector members together so that the pocket portions extend about the head portions and form pockets of the connector; and
securing the connector members together to capture the head portions of the fasteners in the pockets of the connector.

21. The method of claim 20 wherein the cable fasteners include a first cable fastener and a second fastener, the first and second cable fasteners each having a body with a plurality of wide outer surfaces alternating with narrow outer surfaces about the body, the body having rows of threaded openings extending between the narrow outer surfaces and a bore of the body;
wherein securing the cable fasteners to the cable end portions comprises:
securing the first cable fastener to one of the cable end portions;
advancing the other cable end portion into the bore of the second cable fastener; and
positioning one of the narrow outer surfaces of the first or second cable fastener adjacent one of the wide outer surfaces of the other of the first and second cable fasteners.

22. The method of claim 21 wherein the first cable fastener comprises the one of the narrow outer surfaces and the second cable fastener comprises the one of the wide outer surfaces.

23. The method of claim 22 wherein positioning the one of the narrow outer surfaces of the first or second cable fasteners adjacent the one of the wide outer surfaces of the other of the first and second cable fasteners comprises positioning the one of the narrow outer surfaces of the first cable fastener to face the one of the wide outer surfaces of the second cable fastener.

24. The method of claim 21 wherein the first cable fastener comprises the one of the narrow outer surfaces and the second cable fastener comprises the one of the wide outer surfaces;
wherein securing the first cable fastener to the one of the cable end portions comprises tightening down set screws in threaded openings of the one narrow outer surface of the first cable fastener before positioning the one of the narrow outer surfaces of the first or second cable fastener adjacent the one of the wide outer surfaces of the other of the first and second cable fasteners.

25. The method of claim 20 wherein securing the cable fasteners to the cable end portions comprises:
positioning one of the cable end portions in a bore of one of the cable fasteners;
tightening down an outboard set screw of the one cable fastener with an outboard torque to engage the outboard set screw with the one cable end portion in the bore of the one cable fastener; and
tightening down an inboard set screw of the one cable fastener with an inboard torque to engage the inboard set screw with the one cable end portion in the bore of the one cable fastener, the inboard torque being less than the outboard torque.

26. The method of claim 20 wherein securing the connector members together includes securing the connector members together about the fastener head portions via an attachment member.

27. The method of claim 20 wherein securing the connector members together includes engaging retaining rings with the connector members to inhibit separation of the connector members.
